(19) United States
(12) Patent Application Publication
(10) Pub. No.: US 2026/0211352 A1
(43) Pub. Date: Jul. 23, 2026

(54) TONER, PROCESS CARTRIDGE, AND ELECTROPHOTOGRAPHIC IMAGE FORMING APPARATUS

(71) Applicant: CANON KABUSHIKI KAISHA, Tokyo (JP)

(72) Inventor: MASASHI UNO, Shizuoka (JP)

(21) Appl. No.: 19/446,392

(22) Filed: Jan. 12, 2026

(30) Foreign Application Priority Data
Jan. 17, 2025 (JP) 2025-006521
Dec. 11, 2025 (JP) 2025-245145

(51) Int. Cl. G03G 9/093; G03G 9/087; G03G 9/097; G03G 15/08; G03G 21/18

(52) U.S. Cl. CPC G03G 9/09328; G03G 9/08788; G03G 9/09342; G03G 9/09392; G03G 9/09741; G03G 15/0808; G03G 15/0812; G03G 21/1814; G03G 2215/0607

(57) ABSTRACT

A toner comprises (1) a toner particle and (2) an external additive. The toner particle (1) comprises a binder resin, a positive-charge control agent, and an ester compound. The binder resin comprises a resin having a vinyl polymer segment, and a polyester segment containing an alkenylsuccinic unit having an alkenyl group with 10 to 22 carbon atoms. The positive-charge control agent is a nigrosine compound. The ester compound is an ester of pentaerythritol or dipentaerythritol and a saturated or unsaturated aliphatic monocarboxylic acid with 10 to 22 carbon atoms. The external additive (2) includes silicone resin particles.

### BACKGROUND

### Field of the Technology

The present disclosure relates to a toner, a process cartridge, and an electrophotographic image forming apparatus, which are used in image forming methods such as an electrophotographic process.

### Description of the Related Art

Toner is used in electrophotographic image forming apparatuses, such as printers and copiers, to develop latent images formed on a photosensitive member. In order to impart charging characteristics, flowability, and other required properties, toner is typically in such a form that various organic or inorganic fine particles are externally added to toner particle, and such fine particles are referred to as external additives.

An electrophotographic image forming apparatus includes various electrophotographic members, such as a photosensitive member (electrostatic latent image bearing member), a developing roller (toner bearing member), and a toner regulating member. In the image forming process, the toner is repeatedly subjected to frictional contact by these members. The toner deteriorates as it undergoes frictional contact. This deterioration is partly caused by external additives becoming embedded in the toner particle or transferring to the electrophotographic members due to frictional contact, thereby gradually being lost from the surface of the toner particle. As toner deterioration progresses, the chargeability of the toner decreases, which may cause image defects known as fogging. In addition, since the toner becomes more prone to fusing onto electrophotographic members, it may cause defects such as what is called developing-roller filming. Developing-roller filming is a phenomenon in which the surface of the developing roller becomes covered with fused deposits of deteriorated toner, and the portion covered with the fused deposits causes significant image defects such as longitudinal streaks.

For example, Japanese Patent Laid-Open Nos. 2013-140235 and 2016-126140 disclose examples of countermeasures to such toner deterioration in which silicone resin particles are used as external additives. Silicone resin particles are softer and more elastic than inorganic particles such as silica, which are commonly used as an external additive, and are therefore less likely to become embedded in toner particle, facilitating suppression of toner deterioration.

However, in recent years, electrophotographic image forming apparatuses have increasingly been required to achieve higher speeds and longer service life, and the frictional load exerted on toner tends to increase accordingly. In studies by the present inventors, even toners using silicone resin particles as an external additive have occasionally exhibited fogging and developing-roller filming in such severe usage environments.

### SUMMARY

Accordingly, the present disclosure provides a toner capable of forming high-quality images even in higher-speed, longer-life electrophotographic image forming apparatus, while suppressing the occurrence of fogging and developing-roller filming.

The present inventors have conducted intensive research to resolve the above-described disadvantage and found that the following features can resolve the disadvantage.

In the following description, “toner particle” collectively refers to toner particles as a whole unless stated otherwise.

The present disclosure provides a toner comprising a toner particle and an external additive. (1) The toner particle comprises a binder resin, a positive-charge control agent, and an ester compound. The binder resin comprises a resin having a vinyl polymer segment and a polyester segment containing an alkenylsuccinic unit having an alkenyl group with 10 to 22 carbon atoms. The positive-charge control agent is a nigrosine compound. The ester compound is an ester of pentaerythritol or dipentaerythritol and a saturated or unsaturated aliphatic monocarboxylic acid with 10 to 22 carbon atoms. (2) The external additive comprises silicone resin particles.

Also, the present disclosure provides a process cartridge capable of being removably mounted in an electrophotographic image forming apparatus. The process cartridge includes a toner, a developing roller that bears the toner, and a toner regulating member that comes into contact with the developing roller to regulate the toner on the developing roller. The toner comprises a toner particle and an external additive. (1) The toner particle comprises a binder resin, a positive-charge control agent, and an ester compound. The binder resin comprises a resin having a vinyl polymer segment and a polyester segment containing an alkenylsuccinic unit having an alkenyl group with 10 to 22 carbon atoms. The positive-charge control agent is a nigrosine compound. The ester compound is an ester of pentaerythritol or dipentaerythritol and a saturated or unsaturated aliphatic monocarboxylic acid with 10 to 22 carbon atoms. (2) The external additive comprises silicone resin particles.

The present disclosure is also directed to an electrophotographic image forming apparatus including a toner, a photosensitive member on which an electrostatic latent image is formed, a developing roller that bears the toner and develops the electrostatic latent image into a toner image, and a toner regulating member that comes into contact with the developing roller to regulate the toner on the developing roller. The toner comprises a toner particle and an external additive. (1) The toner particle comprises a binder resin, a positive-charge control agent, and an ester compound. The binder resin comprises a resin having a vinyl polymer segment and a polyester segment containing an alkenylsuccinic unit having an alkenyl group with 10 to 22 carbon atoms. The positive-charge control agent is a nigrosine compound. The ester compound is an ester of pentaerythritol or dipentaerythritol and a saturated or unsaturated aliphatic monocarboxylic acid with 10 to 22 carbon atoms. (2) The external additive comprises silicone resin particles.

Features of the present disclosure will become apparent from the following description of embodiments with reference to the attached drawings. The following description of embodiments is described by way of example.

### BRIEF DESCRIPTION OF THE DRAWINGS

The FIGURE is a schematic diagram of the configuration around the developing roller of a process cartridge containing the toner disclosed herein.

### DESCRIPTION OF THE EMBODIMENTS

Details of the present disclosure will now be described, but are not intended to limit the implementation of the disclosure.

In the description presented herein, numerical ranges expressed as “** or more and xx or less” or “** to xx” each includes the lower and the upper limit, which are the values at the ends of the range unless otherwise specified. Also, the term “toner particle” used herein means toner particles as a whole.

### Features of the Disclosure

The present disclosure provides a toner comprising a toner particle and an external additive. (1) The toner particle comprises a binder resin, a positive-charge control agent, and an ester compound. The binder resin comprises a resin having a vinyl polymer segment and a polyester segment containing an alkenylsuccinic unit having an alkenyl group with 10 to 22 carbon atoms. The positive-charge control agent is a nigrosine compound. The ester compound is an ester of pentaerythritol or dipentaerythritol and a saturated or unsaturated aliphatic monocarboxylic acid with 10 to 22 carbon atoms. (2) The external additive comprises silicone resin particles.

The present inventors have found that a toner having the above-described features can form high-quality images throughout its service life even in a higher-speed, longer-life electrophotographic image forming apparatus, while suppressing the occurrence of fogging and developing-roller filming. The details of the reason remain unclear, but can be estimated as follows.

The FIGURE is a schematic diagram of the configuration around the developing roller of a process cartridge that includes a toner, a developing roller, a toner regulating member, a photosensitive member, and a toner supplying roller. In the process of image formation, a toner 2 in a toner container 1 is supplied onto a developing roller 4 by a toner supplying roller 3, and then forms a uniform toner coating layer on the developing roller 4 with a toner regulating member 5. At this time, the toner undergoes strong frictional contact at the contact position between the developing roller 4 and the toner regulating member 5. The toner coating layer is then conveyed to a contact portion with a photosensitive member 6, where a part of the toner is transferred onto the photosensitive member 6 for development, while the toner that has not been developed is stripped from the developing roller 4 by the toner supplying roller 3 after passing through an anti-blowout member 7.

Under severe use conditions involving higher speed and longer service life, the toner repeatedly passes through the above-mentioned contact position between the developing roller and the toner regulating member, and thus receives strong frictional contact repeatedly. As a result, the external additive gradually migrates from the toner to the developing roller, and the toner deteriorates. Probably, the surface of toner particle in the deteriorated toner becomes exposed, and part of the toner particle peels off from the surface as fragments. The toner fragments thus generated can readily fuse onto the developing roller and cause filming. Among the constituents contained in toner particle, particularly those of the release agent have relatively low molecular weights and are readily fusible.

The present inventors believe that, in the composition disclosed herein, interactions among the following constituents (i) to (v) reduce fogging and developing-roller filming:
(i) silicone resin particles;
(ii) nigrosine compound;
(iii) vinyl polymer segment in the binder resin;
(iv) alkenylsuccinic unit having an alkenyl group with 10 to 22 carbon atoms in the polyester segment of the binder resin; and
(v) ester of pentaerythritol or dipentaerythritol and a saturated or unsaturated aliphatic monocarboxylic acid with 10 to 22 carbon atoms.

The silicone resin particles (i), which serve as an external additive, gradually migrate from the toner to the developing roller through repeated frictional contact. The nigrosine compound (ii) is contained in toner particle fragments generated by deterioration. Since the silicone resin particles tend to be negatively charged and the nigrosine compound tends to be positively charged, the toner particle fragments that are positively charged are covered with negatively charged silicone resin particles present on the developing roller and thus come into a state that can readily separate from the developing roller, thereby suppressing developing-roller filming. Furthermore, the toner particle fragments covered with silicone resin particles have moderate chargeability and, therefore, are less likely to cause fogging. The present inventors believe that such toner particle fragments are again attached to the developing roller, forming a coating, and are discharged out of the toner container through the developing process.

Constituent (v), which serves as a release agent, has a relatively low molecular weight among the constituents of the toner particle and is less likely to be charged. Accordingly, constituent (v) alone tends to fuse onto the developing roller. In addition, it cannot be expected to be covered with the negatively charged silicone resin particles (i), tending to act as a factor causing developing-roller filming. However, constituent (v), which is a long-chain fatty acid ester compound, has high compatibility with the alkenylsuccinic unit (iv), which also has a long-chain structure. Meanwhile, the nigrosine compound (ii) has a planar structure with fused aromatic rings and therefore exhibits high affinity for the vinyl polymer segment (iii). Since the vinyl polymer segment (iii), as well as the alkenylsuccinic unit (iv), is an element of the binder resin, the constituents (ii), (iii), (iv), and (v) are present in a mutually miscible state in the toner particle. As a result, constituent (v) serving as a release agent is prevented from fusing onto the developing roller on its own. The present inventors believe that the nigrosine compound (ii) and constituent (v) as a release agent come into a state where they are collectively covered with the negatively charged silicone resin particles (i) and readily separable from the developing roller.

Some embodiments of the toner according to the present disclosure will now be described. However, the following embodiments are not intended to limit the implementation of the present disclosure.

### Toner

The constituents of the toner and the process for producing the toner will be described below.

### Toner Particle

The toner particle used herein contains a binder resin, a positive-charge control agent, and an ester compound.

The amount of the binder resin is preferably 50% or more by mass relative to the total mass of the resin components in the toner particle.

The binder resin contains a resin having a vinyl polymer segment and a polyester segment containing an alkenylsuccinic unit having an alkenyl group with 10 to 22 carbon atoms.

The vinyl polymer segment may have, for example, a chemical structure including a styrene-acrylic copolymer. Styrene-acrylic copolymers include polymers formed of any one of the following monofunctional or polyfunctional polymerizable monomers, copolymers produced by combining two or more of the following monomers, and mixtures of such polymers.

Examples of monofunctional polymerizable monomers include:
styrene; styrene derivatives, such as α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene; polymerizable acrylic monomers, such as methyl acrylate, ethyl acrylate, n-phenyl acrylate, isopropyl acrylate, n-butyl acrylate, isobutyl acrylate, tert-butyl acrylate, n-amyl acrylate, n-hexyl acrylate, 2-ethylhexyl acrylate, n-octyl acrylate, n-nonyl acrylate, cyclohexyl acrylate, benzyl acrylate, dimethylphosphateethyl acrylate, dibutylphosphateethyl acrylate, and 2-benzoyloxyethyl acrylate; polymerizable methacrylic monomers, such as methyl methacrylate, ethyl methacrylate, n-phenyl methacrylate, isopropyl methacrylate, n-butyl methacrylate, isobutyl methacrylate, tert-butyl methacrylate, n-amyl methacrylate, n-hexyl methacrylate, 2-ethylhexyl methacrylate, n-octyl methacrylate, n-nonyl methacrylate, diethylphosphateethyl methacrylate, and dibutylphosphateethyl methacrylate; methylene aliphatic monocarboxylic acid esters; vinyl esters, such as vinyl acetate, vinyl acetate propionate, vinyl butyrate, vinyl benzoate, and vinyl formate; vinyl ethers, such as vinyl methyl ether, vinyl ethyl ether, and vinyl isobutyl ether; vinyl ketones, such as vinyl methyl ketone, vinyl hexyl ketone, and vinyl isopropyl ketone.

Examples of polyfunctional polymerizable monomers include:
diethylene glycol diacrylate, triethylene glycol diacrylate, tetraethylene glycol diacrylate, polyethylene glycol diacrylate, 1,6-hexanediol diacrylate, neopentyl glycol diacrylate, tripropylene glycol diacrylate, polypropylene glycol diacrylate, 2,2′-bis(4-(acryloxy diethoxy)phenyl)propane, trimethylolpropane triacrylate, tetramethylolmethane tetraacrylate, ethylene glycol dimethacrylate, diethylene glycol dimethacrylate, triethylene glycol dimethacrylate, tetraethylene glycol dimethacrylate, polyethylene glycol dimethacrylate, 1,3-butylene glycol dimethacrylate, 1,6-hexanediol dimethacrylate, neopentyl glycol dimethacrylate, polypropylene glycol dimethacrylate, 2,2′-bis(4-(methacryloxy diethoxy)phenyl)propane, 2,2′-bis(4-(methacryloxy polyethoxy)phenyl)propane, trimethylolpropane trimethacrylate, tetramethylolmethane tetramethacrylate, tetramethylolmethane tetramethacrylate, divinylbenzene, divinylnaphthalene, and divinyl ether.

As examples of chemical structures constituting the polyester segment, mention may be made of chemical structures formed from polycondensates of the following carboxylic acid components and alcohol components.

Examples of the carboxylic acid component include an alkenylsuccinic acid having an alkenyl group with 10 to 22 carbon atoms and, as needed, terephthalic acid, isophthalic acid, phthalic acid, fumaric acid, maleic acid, cyclohexanedicarboxylic acid, terephthalic acid, and the like. Examples of the alcohol component include bisphenol A, hydrogenated bisphenol, ethylene oxide adducts of bisphenol A, propylene oxide adducts of bisphenol A, glycerin, trimethylolpropane, and pentaerythritol.

In addition, the polyester resin itself may contain a urea group. Preferably, carboxy groups at the termini or the like of the polyester resin are not capped.

The polyester segment content of the resin having a vinyl polymer segment and a polyester segment is, for example, 40% to 90% by mass, and preferably 50% to 80% by mass.

The hybridization of the vinyl polymer segment and the polyester segment can be conducted, for example, by, but is not limited to, the following methods. In a method, a monomer component capable of reacting with both the vinyl polymer segment and the polyester segment may be incorporated into at least either of these segments. In another method, the polyester segment is subjected to a transesterification reaction with the vinyl polymer segment containing structural units derived from an ester. Examples of monomers capable of reacting with both segments include fumaric acid, acrylic acid, methacrylic acid, citraconic acid, maleic acid, and dimethyl fumarate.

The acid value of the polyester segment is preferably 4.0 mg KOH/g to 10.0 mg KOH/g.

A nigrosine compound is used as the positive-charge control agent. If necessary, the nigrosine compound may be used in combination with other positive-charge control agents such as quaternary ammonium salts, guanidine compounds, and imidazole compounds.

The ester compound is a constituent used as a release agent and is an ester of pentaerythritol or dipentaerythritol and a saturated or unsaturated aliphatic monocarboxylic acid with 10 to 22 carbon atoms.

The amount of the release agent is preferably 1.0 to 30.0 parts by mass relative to 100.0 parts by mass of the binder resin or the polymerizable monomer(s) forming the binder resin.

The melting point of the release agent is preferably 30° C. to 120° C., and more preferably 60° C. to 100° C. The release agent having such thermal properties is efficient in release and securing a wider fixing latitude.

The toner particle may contain a coloring agent. The coloring agent may be selected from known pigments and dyes. The coloring agent is preferably a pigment. Pigments exhibit good weatherability.

Examples of cyan coloring agents include copper phthalocyanine and its derivatives, anthraquinone compounds, and basic dye lakes.

Specific examples include C.I. Pigment Blue 1, 7, 15, 15:1, 15:2, 15:3, 15:4, 60, 62, and 66.

Examples of magenta coloring agents include condensed azo compounds, diketopyrrolopyrrole compounds, anthraquinone compounds, quinacridone compounds, basic dye lakes, naphthol compounds, benzimidazolone compounds, thioindigo compounds, and perylene compounds.

Specific examples include C.I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, and 254 and C.I. Pigment Violet 19.

Examples of yellow coloring agents include condensed azo compounds, isoindolinone compounds, anthraquinone compounds, azo metal complexes, methine compounds, and allyl amide compounds.

Specific examples include C.I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191, and 194.

Examples of black coloring agents include carbon blacks and mixtures whose color is adjusted to black using yellow, magenta, and cyan coloring agents.

Coloring agents may be used individually, in a mixture, or in a solid solution.

The proportion of the coloring agent is preferably 1.0 to 20.0 parts by mass relative to 100.0 parts by mass of the binder resin.

The toner can be a magnetic toner containing magnetic material. In this instance, the magnetic material may also serve as a coloring agent.

Examples of the magnetic material include iron oxides, such as magnetite, hematite, and ferrite; elemental metals such as iron, cobalt, and nickel; and alloys or mixtures of those metals and other metals such as aluminum, cobalt, copper, lead, magnesium, tin, zinc, antimony, beryllium, bismuth, cadmium, calcium, manganese, selenium, titanium, tungsten, and vanadium.

### External Additive

The external additive used herein contains silicone resin particles. From the viewpoint of durability when added to the toner particle, the external additive preferably has a number-average particle size that is 1/10 or less of the weight-average particle size of the toner particle.

The silicone resin particles have a structure in which silicon atoms and oxygen atoms are alternately bonded, and preferably have a T3 unit structure represented by the following formula (2):

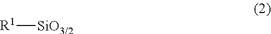

wherein in formula (2), R¹ represents an alkyl group having 1 to 6 carbon atoms (preferably 1 to 4 carbon atoms, more preferably 1 or 2 carbon atoms) or a phenyl group.

In solid-state ²⁹Si NMR measurement of the silicone resin particles, the ratio of the peak area attributable to silicon in the T3 unit structure to the total peak area originating from all silicon atoms contained in the silicone resin particles is preferably from 0.50 to 1.00. Preferably, the ratio is from 0.70 to 1.00.

When the ratio is within such a range, the silicone resin particles have suitable hardness and elasticity and are, therefore, less prone to being crushed even under repeated frictional contact, easily leading to reduced fogging and developing-roller filming.

Silicone resin particles obtained by polymerizing an organosilicon compound having the structure represented by the following formula (3) can be suitably used as the silicone resin particles.

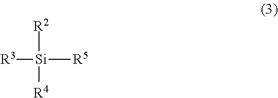

In formula (3), R², R³, R⁴, and R⁵ are each independently an alkyl group with 1 to 6 carbon atoms (preferably 1 to 4 carbon atoms, more preferably 1 or 2 carbon atoms), a phenyl group, or a reactive substituent such as a halogen atom, a hydroxy group, an acetoxy group, or an alkoxy group preferably with 1 to 6 carbon atoms, more preferably 1 to 3 carbon atoms.

Examples of the organosilicon compound to be polymerized include:
organosilicon compounds having four reactive substituents in one molecule of formula (3) (tetrafunctional silanes);
organosilicon compounds of formula (3) in which R² is an alkyl group or a phenyl group and which has three reactive substituents (R³, R⁴, and R⁵) (trifunctional silanes);
organosilicon compounds of formula (3) in which R² and R³ are each an alkyl group or a phenyl group and which has two reactive substituents (R⁴ and R⁵) (difunctional silanes); and
organosilicon compounds of formula (3) in which R², R³, and R⁴ are each an alkyl group or a phenyl group and which has one reactive substituent (R⁵) (monofunctional silanes).

In order to control the ratio of the peak area attributable to silicon in the T3 unit structure to the total peak area originating from all silicon atoms contained in the silicone resin particles in the range of 0.50 to 1.00, a trifunctional silane is preferably used in an amount of 50 mol % or more as the organosilicon compound.

Such reactive substituents undergo hydrolysis, addition polymerization, and condensation polymerization to form a crosslinked structure, thereby yielding silicone resin particles. For example, when a trifunctional silane is used as the organosilicon compound, the hydrolysis, addition polymerization, and condensation polymerization of R³, R⁴, and R⁵ can be controlled by the reaction temperature, reaction time, reaction solvent, and pH.

Examples of tetrafunctional silanes include tetramethoxysilane, tetraethoxysilane, and tetraisocyanatosilane.

Examples of trifunctional silanes include methyltrimethoxysilane, methyltriethoxysilane, methyldiethoxymethoxysilane, methylethoxydimethoxysilane, methyltrichlorosilane, methylmethoxydichlorosilane, methylethoxydichlorosilane, methyldimethoxychlorosilane, methylmethoxyethoxychlorosilane, methyldiethoxychlorosilane, methyltriacetoxysilane, methyldiacetoxymethoxysilane, methyldiacetoxyethoxysilane, methylacetoxydimethoxysilane, methylacetoxymethoxyethoxysilane, methylacetoxydiethoxysilane, methyltrihydroxysilane, methylmethoxydihydroxysilane, methylethoxydihydroxysilane, methyldimethoxyhydroxysilane, methylethoxymethoxyhydroxysilane, methyldiethoxyhydroxysilane, ethyltrimethoxysilane, ethyltriethoxysilane, ethyltrichlorosilane, ethyltriacetoxysilane, ethyltrihydroxysilane, propyltrimethoxysilane, propyltriethoxysilane, propyltrichlorosilane, propyltriacetoxysilane, propyltrihydroxysilane, butyltrimethoxysilane, butyltriethoxysilane, butyltrichlorosilane, butyltriacetoxysilane, butyltrihydroxysilane, hexyltrimethoxysilane, hexyltriethoxysilane, hexyltrichlorosilane, hexyltriacetoxysilane, hexyltrihydroxysilane, phenyltrimethoxysilane, phenyltriethoxysilane, phenyltrichlorosilane, phenyltriacetoxysilane, and phenyltrihydroxysilane, and pentyltrimethoxysilane.

Examples of difunctional silanes include di-tert-butyldichlorosilane, di-tert-butyldimethoxysilane, di-tert-butyldiethoxysilane, dibutyldichlorosilane, dibutyldimethoxysilane, dibutyldiethoxysilane, dichlorodecylmethylsilane, dimethoxydecylmethylsilane, diethoxydecylmethylsilane, dichlorodimethylsilane, dimethyldimethoxysilane, diethoxydimethylsilane, and diethyldimethoxysilane.

Examples of monofunctional silanes include t-butyldimethylchlorosilane, t-butyldimethylmethoxysilane, t-butyldimethylethoxysilane, t-butyldiphenylchlorosilane, t-butyldiphenylmethoxysilane, t-butyldiphenylethoxysilane, dichlorodimethylphenylsilane, methoxydimethylphenylsilane, ethoxydimethylphenylsilane, chlorotrimethylsilane, trimethylmethoxysilane, ethoxytrimethylsilane, triethylmethoxysilane, triethylethoxysilane, tripropylmethoxysilane, tributylmethoxysilane, tripentylmethoxysilane, triphenylchlorosilane, triphenylmethoxysilane, and triphenylethoxysilane.

The silicone resin particles used herein may be surface-treated to impart hydrophobicity to the particles.

Examples of hydrophobization agents include:
chlorosilanes, such as methyltrichlorosilane, dimethyldichlorosilane, trimethylchlorosilane, phenyltrichlorosilane, diphenyldichlorosilane, t-butyldimethylchlorosilane, and vinyltrichlorosilane;
alkoxysilanes, such as isobutyltrimethoxysilane, tetramethoxysilane, methyltrimethoxysilane, dimethyldimethoxysilane, phenyltrimethoxysilane, diphenyldimethoxysilane, o-methylphenyltrimethoxysilane, p-methylphenyltrimethoxysilane, n-butyltrimethoxysilane, isobutyltrimethoxysilane, hexyltrimethoxysilane, octyltrimethoxysilane, decyltrimethoxysilane, dodecyltrimethoxysilane, tetraethoxysilane, methyltriethoxysilane, dimethyldiethoxysilane, phenyltriethoxysilane, diphenyldiethoxysilane, isobutyltriethoxysilane, decyltriethoxysilane, vinyltriethoxysilane, γ-methacryloxypropyltrimethoxysilane, γ-glycidoxypropyltrimethoxysilane, γ-glycidoxypropylmethyldimethoxysilane, γ-mercaptopropyltrimethoxysilane, γ-chloropropyltrimethoxysilane, γ-aminopropyltrimethoxysilane, γ-aminopropyltriethoxysilane, γ-(2-aminoethyl)aminopropyltrimethoxysilane, and γ-(2-aminoethyl)aminopropylmethyldimethoxysilane;
silazanes, such as hexamethyldisilazane, hexaethylsilazane, hexapropyldisilazane, hexabutyldisilazane, hexapentyldisilazane, hexahexyldisilazane, hexacyclohexyldisilazane, hexaphenyldisilazane, divinyltetramethyldisilazane, and dimethyltetravinyldisilazane; and siloxanes, such as hexamethylcyclotrisiloxane, octamethylcyclotetrasiloxane, decamethylcyclopentasiloxane, hexamethyldisiloxane, and octamethyltrisiloxane.

The silicone resin particles used herein preferably contain a toluene-soluble component in an amount of 0.2% to 5.0% by mass. When the toluene-soluble component falls within this range, an appropriate amount of the toluene-soluble component exudes onto the surface of the developing roller, thereby reducing the adhesion of the toner particle to the developing roller and facilitating suppression of developing-roller filming.

The toluene-soluble component preferably has a polystyrene-equivalent weight average molecular weight, as determined by GPC, of 1,000 to 10,000. Within this range, the toluene-soluble component neither penetrates the developing roller nor exhibits excessively high viscosity, consequently facilitating a reduction in the adhesion force of the toner particle to the developing roller.

To impart a toluene-soluble component, a silane compound having a desired molecular weight and low reactivity may be added during the production process.

Examples of the silane compound include silicone oils, such as dimethyl silicone oil, methylhydrogen silicone oil, methylphenyl silicone oil, alkyl-modified silicone oil, chloroalkyl-modified silicone oil, chlorophenyl-modified silicone oil, fatty-acid-modified silicone oil, polyether-modified silicone oil, alkoxy-modified silicone oil, carbinol-modified silicone oil, amino-modified silicone oil, fluorine-modified silicone oil, and terminal-reactive silicone oil.

Preferably, the external additive contains alumina particles in addition to the silicone resin particles. Silicone resin particles tend to be more readily negatively charged through charge exchange with alumina particles and, therefore, cover toner particle fragments more effectively, facilitating the removal of the particle fragments from the developing roller. From the viewpoint of achieving an appropriate balance between positive and negative charge, the mass ratio between the silicone resin particles and the alumina particles is preferably from 30:70 to 70:30.

In addition, the mass ratio of the silicone resin particles to the alumina particles (silicone resin particle content:alumina particle content) in the toner is preferably 30:70 to 70:30. Silicone resin particles tend to be more readily negatively charged through charge exchange with alumina particles and, therefore, cover toner particle fragments more effectively, facilitating the removal of the particle fragments from the developing roller.

Preferably, the number-average particle size A (nm) of the silicone resin particles and the number-average particle size B (nm) of the alumina particles satisfy the following relationship (1):

$$0.05 \leq A / B < 1. \qquad ( 1 )$$

When A/B is in this range, the silicone resin particles are smaller than the alumina particles and are, accordingly, more likely to cover the toner particle fragments and facilitate the suppression of developing-roller filming.

Other external additives, such as organic or inorganic fine powders, may be optionally used in combination. Examples of organic or inorganic fine powders as other external additives include:
(1) flowability imparting agents, such as silica, titanium oxide, carbon black, and carbon fluoride;
(2) abrasives, such as metal oxide (e.g., strontium titanate, cerium oxide, magnesium oxide, and chromium oxide), nitrides (e.g., silicon nitride), carbide (e.g., silicon carbide), and metal salts (e.g., calcium sulfate, barium sulfate, and calcium carbonate);
(3) lubricants, such as fluororesin powder (e.g., polyvinylidene fluoride and polytetrafluoroethylene) and fatty acid metal salts (e.g., zinc stearate and calcium stearate); and
(4) charge controllable particles, such as metal oxides (e.g., tin oxide, titanium oxide, zinc oxide, and silica), carbon black, and hydrotalcite.

The surface of such organic or inorganic fine powder may be hydrophobized to improve the flowability of the toner and allow uniform charging of the toner particle.

Examples of the agent used for hydrophobizing the organic or inorganic fine powder include unmodified silicone varnish, various types of modified silicone varnish, unmodified silicone oil, various types of modified silicone oil, silane compounds, silane coupling agents, other organosilicon compounds, and organotitanium compounds. These hydrophobizing agents may be used individually or in combination.

### Toner Production Method

A method for producing the above-described toner particle will now be described, but the method is not intended to limit the implementation of the present disclosure.

The toner particle may be produced by known methods without limitation, such as suspension polymerization, dissolution suspension, emulsion aggregation, and pulverization. A method for producing toner particle by pulverization will be described below as an example.

### Raw Materials Mixing Step

In the raw material mixing step, materials for the toner particle, for example, a binder resin, a positive-charge control agent, an ester compound, a wax, and optional constituents such as a coloring agent, are mixed in predetermined proportions. The binder resin may be a combination of two or more resins with different molecular weights.

Examples of the mixing apparatus include double-cone mixers, V-shaped mixers, drum mixers, super mixers, Henschel mixers, Nauta mixers, and Mechano Hybrid (manufactured by Nippon Coke & Engineering Co. Ltd.).

### Melt-Kneading Step

Then, the mixed materials are melt-kneaded to disperse the wax and other constituents in the binder resin. In the melt-kneading step, a batch-type kneading machine, such as a pressure kneader or a Banbury mixer, or a continuous kneading machine can be used, and single-screw or twin-screw extruders are predominantly used because of the advantage of continuous production. Examples include a KTK twin-screw extruder (manufactured by Kobe Steel, Ltd.), a TEM twin-screw extruder (manufactured by Shibaura Machine Co., Ltd.; formerly Toshiba Machine Co., Ltd.), a PCM kneader (manufactured by Ikegai Corp.), a twin-screw extruder (manufactured by KCK Co., Ltd.), a Co-Kneader (manufactured by Buss AG), and a Needex (manufactured by Nippon Coke & Engineering Co., Ltd.).

The resin composition produced by melt-kneading may further be rolled using, for example, a two-roll mill, and cooled with water or the like in a cooling step.

The melt-kneading step is preferably performed using a twin-screw extruder. The dispersion state of crystalline resin and amorphous resin, the number-average domain diameter, and the like can be controlled by adjusting the kneading temperature, screw rotational speed, and other parameters in the melt-kneading step.

The kneading temperature is preferably 110° C. to 140° C., and more preferably 115° C. to 130° C.

The screw rotation speed during kneading is not particularly limited and may be appropriately selected depending on the apparatus; for example, 1000 rpm to 1500 rpm is preferred.

### Cooling Step

The cooling step may be performed through any method without limitation. Examples include a method in which the kneaded resin composition is rolled with a twin-roll mill or a drum and then cooled with a steel-belt cooler (manufactured by Nippon Steel Conveyor Co., Ltd.), and a method in which the composition is rolled while being cooled by a press roller and a drum equipped with an internal cooling mechanism, such as a belt-drum flaker (manufactured by Nippon Coke & Engineering Co., Ltd.). Preferably, rolling is performed while the resin composition is being cooled with a belt-drum flaker.

### Pulverization Step

Subsequently, the cooled resin composition is pulverized to a desired particle size in a pulverization step. In the pulverization step, the material is first coarsely crushed using, for example, a crusher, a hammer mill, or a feather mill, and then finely pulverized, for example, with a Cryptron System (manufactured by Kawasaki Heavy Industries, Ltd.), a Super Rotor (manufactured by Nisshin Engineering Inc.), a Turbo Mill (manufactured by Turbo Kogyo Co., Ltd.), or an air-jet type fine pulverizer.

### Classification Step

Then, the pulverized resin composition may optionally be classified to obtain toner particle using an inertial classification Elbow-Jet (manufactured by Nittetsu Mining Co., Ltd.), a centrifugal classification Turboplex (manufactured by Hosokawa Micron Corp.), a TSP Separator (manufactured by Hosokawa Micron Corp.), a Faculty classifier (manufactured by Hosokawa Micron Corp.), a multi-division classifier utilizing the Coanda effect, an air classifier, or a sieving machine.

### External Addition Step

Silicone resin particles serving as an external additive, and optionally alumina and various other organic or inorganic fine powders, are externally added onto the surface of the toner particle to produce the toner.

For externally adding the external additive, predetermined amounts of the classified toner with one or more known external additives are blended and stirred using a mixing apparatus, such as a double-cone mixer, a V-shaped mixer, a drum mixer, a super mixer, a Henschel mixer, a Nauta mixer, Mechano Hybrid (manufactured by Nippon Coke & Engineering Co., Ltd.), or Nobilta (manufactured by Hosokawa Micron Corporation), as an external-addition device.

The external-addition mixing time for externally adding external additives to the toner particle is preferably 3 to 20 minutes. The amount of silicone resin particles to be added is preferably 0.1 to 5.0 parts by mass relative to 100.0 parts by mass of the toner particle.

### Process Cartridge, And Electrophotographic Image Forming Apparatus

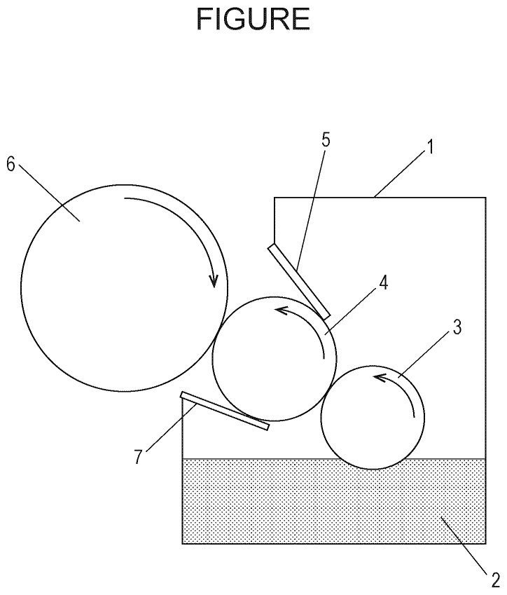

The toner having the above-described composition can be favorably used in a process cartridge as depicted in FIG. 1, which includes a developing roller that bears the toner, and a toner regulating member that comes into contact with the developing roller to regulate the toner and which is removably mounted in the main body of an electrophotographic image forming apparatus, and can also be used in an electrophotographic image forming apparatus including a photosensitive member on which electrostatic latent images will be formed and components involved in a process cartridge.

### Measurement Methods for Physical Properties

Measurement methods for physical properties discussed herein will be described below.

Separation of the Binder Resin and Ester Compound from Toner

The binder resin and the ester compound can be separated from the toner by known methods. An example is described below.

For separating the binder resin and the ester compound, gradient polymer elution chromatography (hereinafter referred to as GPEC) is employed. This analysis enables separation according to the polarity of the compounds, irrespective of molecular weight.

First, the toner is dissolved in chloroform. The sample concentration is adjusted to 0.1 mass % with chloroform, and the resulting solution is filtered through a 0.45 μm PTFE filter to remove insoluble matter. The filtrate is then subjected to measurement.

The analytical conditions for GPEC are as follows:
Instrument: UITIMATE 3000 (manufactured by Thermo Fisher Scientific Inc.)
Mobile phase: A: chloroform (HPLC grade), B: acetonitrile (HPLC grade)
Gradient: 2 min (A/B=0/100)→25 min (A/B=100/0)
(The gradient of the mobile-phase composition is set to be linear.)
Flow rate: 1.0 mL/min
Injection: 0.1 mass %×20 μL
Column: Tosoh TSKgel ODS (4.6 mm in diameter×150 mm, 5 μm)
Column temperature: 40° C.
Detector: Corona charged aerosol detector (Corona-CAD) (manufactured by Thermo Fisher Scientific Inc.)

The binder resin and the ester compound can be separated as distinct peaks according to their polarity from the time-intensity chromatogram obtained in the measurement. Subsequently, the measurement is performed again, and the fractions are collected at the time corresponding to the valley between the peaks, thus separating the binder resin and the ester compound.

### Analysis of Binder Resin

The binder resin used herein is a resin having a vinyl polymer segment and a polyester segment. The composition of the binder resin can be analyzed by ¹H NMR and reactive pyrolysis GC/MS.

### ¹H NMR

A solution prepared as a sample by dissolving 10 mg of the binder resin, which has been separated by the above-described GPEC, in deuterated chloroform is subjected to ¹H NMR measurement under the following conditions:
Measurement instrument: FT NMR spectrometer JNM-EX400 (manufactured by JEOL Ltd.)
Measurement frequency: 400 MHz
Pulse width: 5.0 μs
Spectral width: 10500 Hz
Number of scans: 64
Measurement temperature: 23° C.

The compositional ratios of the monomer units constituting the vinyl polymer segment and the polyester segment can be obtained by analyzing the ¹H NMR spectrum.

### Reactive Pyrolysis GC/MS

Details of the alcohol units and carboxylic units constituting the polyester segment can be identified by selectively cleaving the ester bonds through reactive pyrolysis GC/MS analysis using tetramethylammonium hydroxide (hereinafter referred to as TMAH).

The reactive pyrolysis GC/MS analysis can be performed under the following conditions:
Mass spectrometer: ISQ (manufactured by Thermo Fisher Scientific Inc.)
GC instrument: Focus GC (manufactured by Thermo Fisher Scientific Inc.)
Ion source temperature: 250° C.
Ionization method: Electron ionization (EI)
Mass range: 50 m/z to 1000 m/z
Column: HP-5MS (30 m)
Pyrolyzer: JPS-700 (manufactured by Japan Analytical Industry Co., Ltd.)

A small amount of the binder resin separated by the above GPEC and 1 μL of TMAH are placed on a pyrofoil at 590° C. Pyrolysis GC/MS measurement of the prepared sample is conducted under the above conditions, thereby obtaining peaks corresponding to the alcohol units and carboxylic units constituting the polyester segment. The alcohol units and carboxylic units are detected as their methylated derivatives due to TMAH, which acts as a methylation agent. The structures of the alcohol units and carboxylic units constituting the polyester segment can be identified by analyzing the obtained peaks.

### Analysis of the Ester Compound

The ester compound separated by GPEC is analyzed as a sample by the above-described reactive pyrolysis GC/MS. The structure of the ester compound can be identified by analyzing the obtained peaks.

### Procedure for Separating External Additives Contained in Toner

For separating inorganic external additives, such as alumina particles and silica particles, and silicone resin particles contained in the toner, the inorganic external additives are first separated from the toner particle and the silicone resin particles by using differences in specific gravity. Subsequently, the toner particle and the silicone resin particles are separated by using differences in particle size.

Since the true specific gravity of inorganic external additives such as alumina particles and silica particles is 2.0 or higher, whereas that of toner particle and the silicone resin particles is about 1.0 to 1.3, the separation procedure based on specific gravity uses the fact that saturated sucrose solution has a specific gravity of 1.33 at 20° C.

To prepare the saturated sucrose solution, 200 g of sucrose is added to 100 g of ion-exchanged water, dissolved while being heated in a water bath, and then cooled to 20° C. Into a centrifuge tube, 31 g of the saturated sucrose solution and 6 g of Contaminon N (10% aqueous solution of pH 7 neutral detergent for cleaning precision measuring instruments, containing a nonionic surfactant, an anionic surfactant, and an organic builder; produced by FUJIFILM Wako Pure Chemical Corporation) are weighed, and 1.0 g of toner is further added. The mixture is then shaken using “KM Shaker” (model V-SX), manufactured by Iwaki Sangyo Co., Ltd. at 350 reciprocations per minute for 20 minutes. Then, centrifugation is performed at 3500 rpm for 30 minutes. After centrifugation, the toner particle and silicone resin particles having lower specific gravity are present in the upper layer of the tube, while inorganic external additives having higher specific gravity settle in the lower layer. After separating the aqueous solutions of the upper and lower layers, the separated solutions are dried to obtain a mixture of the toner particle and silicone resin particles from the upper layer and a mixture of inorganic external additives from the lower layer.

The resulting mixture of the toner particle and silicone resin particles is dispersed in a mixed solution of 5 g of ion-exchanged water and 1 g of Contaminon N.

The dispersion liquid is then filtered through a PTFE filter having a pore size of 1 μm to separate the toner particle, and silicone resin particles are recovered from the filtrate.

### Identification of Silicone Resin Particles, Confirmation of T3 Unit Structures, and Calculation of Peak Ratio of T3 Unit Structure in Silicone Resin Particles

The composition and the proportions of the constituent compounds of the silicone resin particles contained in the toner are identified using NMR. If silicone resin particles are available independently, the silicone resin particles can be measured alone.

When silicone resin particles are extracted from toner, the toner is dispersed in a dispersion medium, and the silicone resin particles are detached using a shaker or an ultrasonic homogenizer, as described in “Procedure for Separating External Additives Contained in Toner”. Then, they can be separated by using differences in specific gravity and particle size. The dispersion medium may be, for example, a solution prepared by dissolving sucrose (produced by Kishida Chemical Co., Ltd.) in ion-exchanged water.

The specific gravity of the sucrose solution can be adjusted as desired to a range suitable for separating external additives by varying the concentration of sucrose. During this process, ultrasonic waves are applied while the vial is cooled with ice water so that the dispersion liquid does not increase in temperature.

### Procedure for Solid-State ²⁹Si NMR Analysis

The proportions of the constituent compounds of the silicone resin particles are measured and calculated by solid-state ²⁹Si NMR. Specifically, solid-state ²⁹Si NMR analysis is used to confirm the presence of the T3 unit structure in the silicone resin particles and to calculate the ratio of the peak area attributable to silicon in the T3 unit structure to the total peak area originating from all silicon atoms. In solid-state ²⁹Si NMR, peaks are detected in different chemical-shift regions depending on the structures of functional groups bonded to Si in the constituent compounds of the silicone resin particles.

The structures of the functional groups corresponding to each peak are identified using reference samples. Also, the proportions of the constituent compounds are calculated from the obtained peak areas. The ratio of the peak area of the T3 unit structure to the total peak area can be determined by calculation. The measurement conditions for the solid-state ²⁹Si NMR analysis are as follows:
Instrument: JNM-ECX 5002 (manufactured by JEOL RESONANCE)
Temperature: room temperature
Measurement method: Double Decoupling Magic-Angle Spinning (DDMAS), ²⁹Si, 450 pulse
Sample tube: zirconia, 3.2 mm in diameter
Sample: packed as powder into the sample tube
Sample spinning rate: 10 kHz
Relaxation delay: 180 s
Number of Scans: 2000

After the measurement, multiple silane components of the silicone resin particles, differing in substituent and bonding groups, are peak-separated by curve fitting into the X1, X2, X3, and X4 structures presented below, and the peak areas of each structure are calculated. The following X3 structure falls under the T3 unit structure.

X1 structure: (Ri)(Rj)(Rk)SiO_{1/2} (A1)

X2 structure: (Rg)(Rh)Si(O_{1/2})₂ (A2)

X3 structure: RmSi(O_{1/2})₃ (A3)

X4 structure: Si(O_{1/2})₄ (A4)
wherein in formulas (A1) to (A4), Ri, Rj, Rk, Rg, Rh, and Rm each independently represent a hydrocarbon group with one or more carbon atoms, a halogen atom, or the like bonded to silicon.

Peak areas are calculated according to the following procedure.

First, a baseline is established for the obtained solid-state ²⁹Si NMR spectrum. The baseline is defined as a straight line connecting two plotted points: one at a chemical shift of +50 ppm with an intensity value B1, and another at a chemical shift of −150 ppm with an intensity value B2, wherein B1 is the arithmetic mean of the intensity values in the range of +40 ppm to +60 ppm, and B2 is the arithmetic mean of the intensity values in the range of −160 ppm to −140 ppm.

Peak X1, which originates from the X1 structure, is observed at a chemical shift in the range of +10 ppm to +20 ppm. The peak area of Peak X1 in the chemical shift range of 0 ppm to +30 ppm is defined as S_{X1}. S_{X1} is the integral value of the area enclosed by the solid-state ²⁹Si NMR spectrum and the baseline.

Peak X2, which originates from the X2 structure, is observed at a chemical shift in the range of −25 ppm to −15 ppm. The peak area of Peak X2 in the chemical shift range of −30 ppm to 0 ppm is defined as S_{X2}. S_{X2} is the integral value of the area enclosed by the solid-state ²⁹Si NMR spectrum and the baseline.

Peak X3, which originates from the X3 structure, is observed at a chemical shift in the range of −70 ppm to −50 ppm. The peak area of Peak X3 in the chemical shift range of −80 ppm to −40 ppm is defined as S_{X3}. S_{X3} is the integral value of the area enclosed by the solid-state ²⁹Si NMR spectrum and the baseline.

Peak X4, which originates from the X4 structure, is observed at a chemical shift in the range of −120 ppm to −90 ppm. The peak area of Peak X4 in the chemical shift range of −130 ppm to −80 ppm is defined as S_{X4}. S_{X4} is the integral value of the area enclosed by the solid-state ²⁹Si NMR spectrum and the baseline.

Using the obtained peak areas S_{X1}, S_{X2}, S_{X3}, and S_{X4}, the ratio of the peak area attributable to silicon atoms having the T3 unit structure to the total peak area originating from all silicon atoms is calculated according to the following equation: (Ratio of peak area attributable to silicon atoms having the T3 unit structure to the total peak area originating from all silicon atoms)=S_{X3}/(S_{X1}+S_{X2}+S_{X3}+S_{X4})

### Determination of Soluble Component and Molecular Weight Measurement of Silicone Resin Particles

The silicone resin particles are separated from the toner by centrifugation using a dispersion medium such as the sucrose solution described above. The mass of the resulting silicone resin particles is measured and recorded as the “initial mass.” The silicone resin particles are then dispersed in toluene in an amount ten times the particle mass, allowed to stand for 24 hours, and subsequently subjected to centrifugation to separate the toluene-insoluble component. The obtained toluene-insoluble component is dried at 120° C. for 2 hours, and its mass is measured and recorded as the “mass after toluene extraction.” From the “initial mass” and “mass after toluene extraction,” the amount of the toluene-soluble component of the silicone resin particles is calculated according to the following equation:

Amount of soluble component(mass %)={(initial mass)−(mass after toluene extraction)}/(initial mass)×100

Meanwhile, the solution obtained after separating the toluene-insoluble component by centrifugation is filtered through a solvent-resistant membrane filter (“Maeshori Disk,” manufactured by Tosoh Corporation) having a pore size of 0.2 μm to obtain a sample solution. Using this sample solution, GPC measurement is performed under the following conditions:
Instrument: High-performance gel permeation chromatograph “HLC-8220GPC” manufactured by Tosoh Corporation
Column: combination of two LF-604 columns, manufactured by Showa Denko K.K.
Eluent: Toluene
Flow rate: 0.6 mL/min
Oven temperature: 40° C.
Sample injection volume: 0.020 mL

For calculating the molecular weight of the sample, a molecular weight calibration curve is prepared using standard polystyrene resins (trade names “TSK Standard Polystyrenes F-850, F-450, F-288, F-128, F-80, F-40, F-20, F-10, F-4, F-2, F-1, A-5000, A-2500, A-1000, and A-500,” produced by Tosoh), and the weight average molecular weight is calculated.

### Mass Ratio Between Silicone Resin Particles and Alumina Particles

The mass ratio between the silicone resin particles and alumina particles contained in the toner can be determined by X-ray fluorescence analysis, solid-state ²⁹Si NMR analysis, and GC/MS analysis. The following describes the procedure in the case of using silicone resin particles, alumina particles, and silica particles as external additives.

### (i) X-ray Fluorescence Analysis

X-ray fluorescence measurement is conducted in accordance with JIS K 0119-1969, specifically as described below. The measurement uses a wavelength-dispersive X-ray fluorescence spectrometer “Axios” (manufactured by PANalytical B.V.) and the accompanying dedicated software “SuperQ ver. 5.0 L” (produced by PANalytical B.V.) for setting the measurement conditions and analyzing the measurement data. Using Rh as the anode of the X-ray tube, the measurement is conducted in a vacuum atmosphere, and the measurement diameter (collimator mask diameter) is 27 mm. Using the Omnian method, the range of elements from F to U is measured. Detection is performed with a proportional counter (PC) for light elements and a scintillation counter (SC) for heavy elements. The accelerating voltage and current of the X-ray generator are adjusted to achieve a power of 2.4 kW.

The measuring sample is a pellet of about 2 mm in thickness and about 39 mm in diameter formed by placing 4 g of toner particle in a special aluminum press ring, flatting the particles, and pressing the particles at 20 MPa for 60 s using a tablet-forming press machine “BRE-32” (manufactured by Maekawa Testing Machine Mfg. Co., Ltd.) The pellet pressed under the above conditions is irradiated with X-rays, and the generated characteristic X-rays (fluorescent X-rays) are dispersed by a diffraction crystal. The intensity of the fluorescent X-rays dispersed at the angles corresponding to the wavelengths characteristic of each element contained in the sample is then analyzed by an FP method (Fundamental Parameters method), and the proportion of each element contained in the toner is obtained as the analysis result. Let WS1 denote the mass ratio of silicon atoms to the total mass of silicon and aluminum atoms contained in the toner, and WA1 denote the mass ratio of aluminum atoms to the same total mass. Here, WS1 represents the ratio of the combined mass of silicon atoms contained in the inorganic external additives and those contained in the silicone resin particles in the toner.

Next, the inorganic external additives separated by the above-described “Procedure for Separating External Additives Contained in Toner” are subjected as a sample to X-ray fluorescence measurement in the same manner. Let WS2 denote the mass ratio of silicon atoms to the total mass of silicon and aluminum atoms contained in the inorganic external additives, and WA2 denote the mass ratio of aluminum atoms to the same total mass. Here, WS2 represents the mass ratio of silicon atoms contained in the inorganic external additives in the toner.

Furthermore, let WS1A denote the mass ratio of silicon atoms contained in the inorganic external additives in the toner to the total mass of silicon and aluminum atoms in the toner, and WS1B denote the mass ratio of silicon atoms contained in the silicone resin particles to the total mass of silicon and aluminum atoms in the toner.

The values of WS1, WA1, WS1A, WS1B, WS2, and WA2 satisfy the following relationships (α) and (β):

$$WS 1 / WA 1 = ( WS 1 A + WS 1 B ) / WA 1 \qquad ( α )$$

$$WS 2 / WA 2 = WS 1 A / WA 1 \qquad ( β )$$

Equations (α) and (β) derive the following equation (7):

$$WS 1 B = \{ ( WS 1 / WA 1 ) - ( WS 2 / WA 2 ) \} \times WA 1 \qquad ( γ )$$

The values of WS1, WA1, WS2, and WA2 can be obtained from the X-ray fluorescence measurements described above, and by substituting these values into equation (γ), WS1B can be calculated.

### (ii) Solid ²⁹Si NMR Analysis

The silicone resin particles separated by the above-described “Procedure for Separating External Additives Contained in Toner” are subjected as a measurement sample to solid-state ²⁹Si NMR analysis. The solid-state ²⁹Si NMR analysis is conducted in accordance with the above-described “Procedure for Solid-State ²⁹Si NMR Analysis” to obtain the peak areas S_{X1}, S_{X2}, S_{X3}, and S_{X4} for the silicone resin particles. Using the obtained peak areas S_{X1}, S_{X2}, S_{X3}, and S_{X4}, the ratio of the peak area attributable to silicon having each structure to the total peak area originating from all silicon atoms is calculated. The ratio of the peak area attributable to silicon having the X1 structure is defined as P_{X1}; the ratio of the peak area attributable to silicon having the X2 structure is defined as P_{X2}; the ratio of the peak area attributable to silicon having the X3 structure is defined as P_{X3}; and the ratio of the peak area attributable to silicon having the X4 structure is defined as P_{X4}.

(iii) GC/MS Analysis

An aliquot of 500 mg of the silicone resin particles separated by the above-described “Procedure for Separating External Additives Contained in Toner” is placed in a 300 mL flask, and 250 mg of sulfuric acid is added. The mixture is then heated to 60° C. and allowed to stand for 1 hour. Then, a mixture of 27 g of trimethyl orthoformate and 8.5 g of methanol is added to the flask, and the reaction is carried out at a reflux temperature (170° C.) for 8 hours. This reaction cleaves the siloxane bonds in the silicone resin particles to produce the compounds Y1, Y2, Y3, and Y4 presented below, which originate from the X1, X2, X3, and X4 structures in the silicone resin particles, respectively.

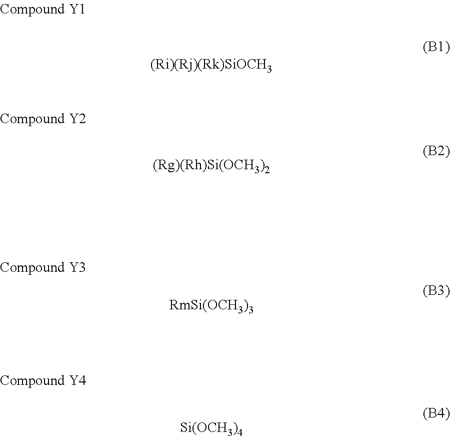

wherein in formulas (B1) to (B4), Ri, Rj, Rk, Rg, Rh, and Rm each independently represent a hydrocarbon group with one or more carbon atoms, a halogen atom, or the like bonded to silicon.

The solution resulting from the reaction, diluted with methanol, is subjected as a sample to GC/MS analysis under the following conditions:
Mass spectrometer: ISQ (manufactured by Thermo Fisher Scientific Inc.)
GC analyzer: Focus GC (manufactured by Thermo Fisher Scientific Inc.)
Inlet temperature: 250° C.
Injection volume: 1 μL
Column oven temperature: 40° C.→300° C. (15° C./min)
Ion source temperature: 250° C.
Ionization method: Electron ionization (EI)
Mass range: 50 m/z to 1000 m/z
Column: HP-5MS (30 m)

The chromatogram thus obtained shows peaks originating from compounds Y1, Y2, Y3, and Y4, each detected at a different retention time. The molecular weights of compounds Y1, Y2, Y3, and Y4 can be determined by examining the mass spectrum of each peak. The molecular weights of the X1, X2, X3, and X4 structures are calculated based on the molecular weights of compounds Y1, Y2, Y3, and Y4. The calculated molecular weight of the X1 structure is defined as M_{X1}; that of the X2 structure is defined as M_{X2}; that of the X3 structure is defined as M_{X3}; and that of the X4 structure is defined as M_{X4}.

### (iv) Calculation of Mass Ratio Between Silicone Resin Particles and Alumina Particles

The mass ratio of the silicone resin particles to the alumina particles in the external additive (mass ratio of the silicone resin particle content to alumina particle content of the toner, silicone resin particle content:alumina particle content) is calculated using the values obtained in (i) to (iii). The calculation uses the following equation:

$$Mass ratio of silicone resin particles to alumina particles in the external additive = \{ WS 1 B \times ( {P}_{X 1} \times {M}_{X 1} + {P}_{X 2} \times {M}_{X 2} + {P}_{X 3} \times {M}_{X 3} + {P}_{X 4} \times {M}_{X 4} ) \} : ( WA 1 \times 51 )$$

### Particle Sizes of Silicone Resin Particles and Alumina Particles

The number-average particle sizes of the silicone resin particles and alumina particles can be measured using a scanning electron microscope (SEM). The toner to which the particles have been added, or the inorganic external additives and silicone resin particles separated by the above-described “Procedure for Separating External Additives Contained in Toner”, are observed. The number-average particle sizes are determined by measuring the longest diameter of 100 randomly selected particles within a field of view magnified up to 50,000 times. The magnification for observation is adjusted as appropriate depending on the particle size. The detailed conditions for SEM observation are as follows:
Instrument: ULTRA PLUS (manufactured by Carl Zeiss Microscopy GmbH)
Acceleration voltage: 1.0 kV
WD: 2.0 mm
Aperture size: 30.0 μm
Detected signal: EsB (energy-selective backscattered electrons)
EsB grid: 800 V
Contrast: 63.0±5.0% (reference)
Brightness: 38.0±5.0% (reference)
Resolution: 1024×768 pixels
Pretreatment: Dispersing the toner or particles on carbon tape (no evaporation coating)

When multiple types of particles such as silicone resin particles and alumina particles are present in the toner, the elemental composition is identified by superimposing an elemental mapping image obtained by energy-dispersive X-ray spectroscopy (EDS) using a scanning electron microscope (SEM) and a backscattered electron image, thereby distinguishing the particles.

When the inorganic external additives include multiple types of particles such as silica particles and alumina particles, the elemental composition is identified by superimposing an elemental mapping image obtained by EDS using an SEM and a backscattered electron image, and particles in which aluminum and oxygen are detected are determined as alumina particles and used as measurement targets. The detailed conditions for EDS are as follows:
SEM instrument: ULTRA PLUS (manufactured by Carl Zeiss Microscopy GmbH)
EDS instrument: NORAN System 7 and Ultra Dry EDS Detector, manufactured by Thermo Fisher Scientific Inc.
Acceleration voltage: 5.0 kV
WD: 7.0 mm
Aperture size: 30.0 μm
Detected signal: SE2 (secondary electrons)
Mode: Spectral imaging
Pretreatment: Dispersing the toner or particles on carbon tape (no evaporation coating)

If the silicone resin particles or alumina particles are available individually, the particles can be measured independently.

### Method for Measuring Weight-Average Particle Size (D4)

The weight-average particle size (D4) of the toner or toner particle is calculated as follows.

A precision particle size distribution analyzer based on the pore electrical resistance method, “Coulter Counter Multisizer 3” (registered trademark, manufactured by Beckman Coulter, Inc.), equipped with a 100 μm aperture tube, is used as the measurement apparatus.

The measurement conditions and analysis of measurement data are performed using the dedicated software “Beckman Coulter Multisizer 3 Version 3.51” (supplied from Beckman Coulter, Inc.). The effective number of measurement channels is 25,000.

The aqueous electrolyte solution used for the measurement can be prepared by dissolving highest-quality sodium chloride in ion-exchanged water to give a concentration of 1.0%, and, for example, “ISOTON II” (produced by Beckman Coulter, Inc.) may be used.

Before the measurement and analysis, the above-mentioned dedicated software is set up as described below.

On the screen “Modify Standard Measurement Method (SOMME) (translated menu title)” of the software, the total count number in the control mode is set to 50,000 particles, the number of measurements is set to one, and the Kd value is set to the value obtained using “10.0 μm Standard Particles” (produced by Beckman Coulter, Inc.). On pressing the “threshold/noise level measurement button (translated menu title)”, the threshold and noise level are automatically set. The Current is set to 1,600 μA; the Gain to 2; and the electrolyte solution to ISOTON II, and the “Flush Aperture Tube After Measurement (translated menu title)” option is checked.

On the “Conversion from Pulse to Particle Size (translated menu title)” screen of the dedicated software, the bin interval is set to logarithmic particle size, the particle size bins to 256 bins, and the particle size range to 2 μm to 60 μm.

More specifically, the measurement is performed according to the following procedure.
(1) Into a 250 mL round-bottom glass beaker dedicated to the Multisizer 3, 200.0 mL of the aqueous electrolyte solution is added and stirred with a stirrer rod counterclockwise at 24 revolutions per second with the beaker set on a sample stand. Contamination and air bubbles inside the aperture tube are removed by the “Aperture Tube Flush” function of the dedicated software.
(2) Into a 100 mL flat-bottom glass beaker, 30.0 mL of the aqueous electrolyte solution is added. To this solution, 0.3 mL of a dilute solution is added as a dispersant. The dilute solution is prepared by diluting “CONTAMINON N” (a 10% aqueous solution of pH 7 neutral detergent for cleaning precision instruments, containing a nonionic surfactant, an anionic surfactant, and an organic builder; manufactured by FUJIFILM Wako Pure Chemical Corporation) to three times its mass with ion-exchanged water.
(3) An ultrasonic disperser “Ultrasonic Dispersion System Tetora 150” (manufactured by Nikkaki Bios Co., Ltd.), having an electrical power of 120 W and containing two oscillators with an oscillation frequency of 50 kHz and a phase difference of 180°, is prepared. Into the water bath of the ultrasonic disperser, 3.3 L of ion-exchanged water is added, and 2.0 mL of CONTAMINON N is added to the bath.
(4) The beaker prepared in the above-described (2) is placed into a beaker-holder opening of the ultrasonic disperser, and the ultrasonic disperser is activated. Then, the height of the beaker is adjusted so that the surface of the aqueous electrolyte solution in the beaker exhibits the maximum resonance.
(5) While ultrasonic waves are applied to the aqueous electrolyte solution in the beaker of (4), 10 mg of toner particle or other sample is added little by little to the electrolyte solution and dispersed. Then, ultrasonic dispersion is continued for an additional 60 s. For the ultrasonic dispersion, the temperature of the water in the water bath is appropriately controlled to a range of 10° C. to 40° C.
(6) The aqueous electrolyte solution prepared in (5), in which the toner particle or other sample is dispersed, is dropped with a pipette into the round-bottom beaker of (1) set in the sample stand to adjust the measured concentration to about 5%. The measurement is then performed until the number of measured particles reaches 50,000.
(7) The measurement data are analyzed using the software dedicated to the apparatus to calculate the weight-average particle size (D4). The “Average size (translated title)” on the “Analysis/Volume Statistics (Arithmetic Mean) (translated menu title)” screen when the display mode is set to “Graph/Volume %” in the dedicated software corresponds to the weight-average particle size (D4).

### EXAMPLES

Specific examples of the present disclosure and comparative examples will be described below, but are not intended to limit the implementation of the disclosure. In the production processes and Examples, “part(s)” refer to quantities on a mass basis unless otherwise specified.

### Synthesis Example of Alkenylsuccinic Acid 1

A flask was charged with 252 g of 1-octadecene and 98 g of maleic anhydride, heated to 180° C. under a nitrogen atmosphere, and 8.8 g of di-tert-butyl peroxide was added over 2 hours with care to control the exotherm, thereby carrying out a radical copolymerization reaction. After completion of the addition, the resulting mixture was maintained at 180° C. for 1 hour and then cooled to room temperature to obtain alkenylsuccinic acid 1 having an alkenyl group with 18 carbon atoms.

### Synthesis Examples of Alkenylsuccinic Acids 2 to 5

Alkenylsuccinic acids 2 to 5 were prepared in the same manner as in the synthesis example of alkenylsuccinic acid 1, except that the raw materials used were changed as presented in Table 1.

TABLE 1

| | | | | | | | Alkenyl |
|---|---|---|---|---|---|---|---|
| | | | | | | | group |
| | | Mass | | Mass | | Mass | carbon |
| | Carboxylic acid | [g] | Alkene | [g] | Initiator | [g] | number |
| Alkenylsuccinic acid 1 | Maleic anhydride | 98 | 1- | 252 | Di-tert-butyl | 8.8 | 18 |
| | | | Octadecene | | peroxide | | |
| Alkenylsuccinic acid 2 | Maleic anhydride | 98 | 1-Decene | 140 | Di-tert-butyl | 8.8 | 10 |
| | | | | | peroxide | | |
| Alkenylsuccinic acid 3 | Maleic anhydride | 98 | 1-Docosene | 309 | Di-tert-butyl | 8.8 | 22 |
| | | | | | peroxide | | |
| Alkenylsuccinic acid 4 | Maleic anhydride | 98 | 1-Nonene | 126 | Di-tert-butyl | 8.8 | 9 |
| | | | | | peroxide | | |
| Alkenylsuccinic acid 5 | Maleic anhydride | 98 | cis-9- | 323 | Di-tert-butyl | 8.8 | 23 |
| | | | Tricosene | | peroxide | | |

### Synthesis Example of Binder Resin 1

Into a reaction vessel, 900 g of 2,2-bis(4-hydroxyphenyl)propane ethylene oxide adduct, 160 g of terephthalic acid, 120 g of trimellitic acid, and 350 g of alkenylsuccinic acid 1 were added, and the mixture was stirred while being heated to 135° C. under a nitrogen atmosphere. To this mixture, a mixed solution of 420 g of styrene, 250 g of butyl acrylate, and 10 g of azobisisobutyronitrile was added dropwise over 1 hour. After the addition, the resulting mixture was maintained at 135° C. for 2 hours and then heated to 230° C. for a reaction for 4 hours, thereby obtaining binder resin 1 having a vinyl polymer segment and a polyester segment.

### Synthesis Examples of Binder Resins 2 to 5

Binder resins 2 to 5 were obtained in the same manner as in the Synthesis Example of Binder Resin 1, except that the raw materials used were changed as presented in Tables 2-1 and 2-2.

TABLE 2-1

| | Polyester | | | | | | | |
|---|---|---|---|---|---|---|---|---|
| | | Mass | | Mass | | Mass | | Mass |
| | Monomer 1 | [g] | Monomer 2 | [g] | Monomer 3 | [g] | Monomer 4 | [g] |
| Binder | 2,2-Bis(4- | 900 | Terephthalic | 160 | Trimellitic | 120 | Alkenylsuccinic | 350 |
| resin 1 | hydroxyphenyl)propane | | acid | | acid | | acid 1 | |
| | ethylene oxide adduct | | | | | | | |
| Binder | 2,2-Bis(4- | 900 | Terephthalic | 160 | Trimellitic | 120 | Alkenylsuccinic | 240 |
| resin 2 | hydroxyphenyl)propane | | acid | | acid | | acid 2 | |
| | ethylene oxide adduct | | | | | | | |
| Binder | 2,2-Bis(4- | 900 | Terephthalic | 160 | Trimellitic | 120 | Alkenylsuccinic | 410 |
| resin 3 | hydroxyphenyl)propane | | acid | | acid | | acid 3 | |
| | ethylene oxide adduct | | | | | | | |
| Binder | 2,2-Bis(4- | 900 | Terephthalic | 160 | Trimellitic | 120 | Alkenylsuccinic | 230 |
| resin 4 | hydroxyphenyl)propane | | acid | | acid | | acid 4 | |
| | ethylene oxide adduct | | | | | | | |
| Binder | 2,2-Bis(4- | 900 | Terephthalic | 160 | Trimellitic | 120 | Alkenylsuccinic | 420 |
| resin 5 | hydroxyphenyl)propane | | acid | | acid | | acid 5 | |
| | ethylene oxide adduct | | | | | | | |

TABLE 2-2

| | Vinyl copolymer | | | | | |
|---|---|---|---|---|---|---|
| | | Mass | | Mass | | Mass |
| | Monomer 5 | [g] | Monomer 6 | [g] | Initiator | [g] |
| Binder resin 1 | Styrene | 420 | Butyl acrylate | 250 | Azobisisobutyronitrile | 10 |
| Binder resin 2 | Styrene | 420 | Butyl acrylate | 250 | Azobisisobutyronitrile | 10 |
| Binder resin 3 | Styrene | 420 | Butyl acrylate | 250 | Azobisisobutyronitrile | 10 |
| Binder resin 4 | Styrene | 420 | Butyl acrylate | 250 | Azobisisobutyronitrile | 10 |
| Binder resin 5 | Styrene | 420 | Butyl acrylate | 250 | Azobisisobutyronitrile | 10 |

### Synthesis Example of Ester Compound 1

A mixture of 64 g of dipentaerythritol, 569 g of stearic acid, 6 g of p-toluenesulfonic acid, and 700 g of toluene was heated to 110° C. for a reaction. The water produced during the reaction was removed by azeotropic distillation with toluene. The reaction was continued for 4 hours. When water no longer distilled off, the reaction was terminated, and an aqueous sodium hydroxide solution was added to neutralize the reaction mixture, followed by washing with water. After removing the aqueous layer, toluene was distilled off under reduced pressure to obtain ester compound 1 having a carboxylic unit with 18 carbon atoms.

### Synthesis Examples of Ester Compounds 2 to 6

Ester compounds 2 to 6 were obtained in the same manner as in the Synthesis Example of Ester Compound 1, except that the raw materials used were changed as presented in Table 3.

TABLE 3

| | | | Carboxylic | | | | | |
|---|---|---|---|---|---|---|---|---|
| | | | acid | | | | | |
| | | Mass | (Carbon | Mass | | Mass | | Mass |
| | Alcohol | [g] | number) | [g] | Acid catalyst | [g] | Solvent | [g] |
| Ester compound 1 | Dipentaerythritol | 64 | Stearic acid | 569 | p-Toluenesulfonic acid | 6 | Toluene | 700 |
| | | | (18) | | | | | |
| Ester compound 2 | Dipentaerythritol | 64 | Decanoic | 345 | p-Toluenesulfonic acid | 6 | Toluene | 550 |
| | | | acid | | | | | |
| | | | (10) | | | | | |
| Ester compound 3 | Dipentaerythritol | 64 | Behenic | 681 | p-Toluenesulfonic acid | 6 | Toluene | 800 |
| | | | acid | | | | | |
| | | | (22) | | | | | |
| Ester compound 4 | Pentaerythritol | 34 | Stearic acid | 569 | p-Toluenesulfonic acid | 6 | Toluene | 700 |
| | | | (18) | | | | | |
| Ester compound 5 | Dipentaerythritol | 64 | Nonanoic | 316 | p-Toluenesulfonic acid | 6 | Toluene | 550 |
| | | | acid | | | | | |
| | | | (9) | | | | | |
| Ester compound 6 | Dipentaerythritol | 64 | Tricosylic | 709 | p-Toluenesulfonic acid | 6 | Toluene | 800 |
| | | | acid | | | | | |
| | | | (23) | | | | | |

### Production Example of Toner Particle 1

Binder resin 1: 100 parts
Carbon black (Nipex 35, produced by Orion Engineered Carbons): 10 parts
Ester compound 1: 6 parts
Nigrosine compound (NUBIAN BLACK TN-870, produced by Orient Chemical Industries): 3 parts

The raw materials presented above were mixed in a Henschel mixer for 3 minutes, and the resulting mixture was melt-kneaded using a twin-screw extruder PCM-30 heated to 160° C. After being cooled on a cooling belt (cooling water at 15° C.), the mixture was coarsely crushed with a hammer mill. The toner temperature immediately after discharge was 155° C. during melt-kneading. The coarsely crushed product was finely pulverized with a turbo mill (manufactured by Turbo Kogyo Co., Ltd.) with the exhaust temperature adjusted to 45° C., and the obtained finely pulverized product was classified with an air classifier to yield toner particle 1 (D4=7.6 μm).

### Production Examples of Toner Particles 2 to 11

Toner particles 2 to 11 were obtained in the same manner as in the Production Example of Toner Particle 1, except that the raw materials used were changed as presented in Table 4.

TABLE 4

| | | Mass | Carbon | Mass | | Mass | Nigrosine | Mass | D4 |
|---|---|---|---|---|---|---|---|---|---|
| | Binder resin | parts | black | parts | Ester compound | parts | compound | parts | [μm] |
| Toner particle 1 | Binder resin 1 | 100 | Nipex35 | 10 | Ester compound 1 | 6 | NUBIAN | 3 | 7.6 |
| | | | | | | | BLACK | | |
| | | | | | | | TN-87 | | |
| Toner particle 2 | Binder resin 2 | 100 | Nipex35 | 10 | Ester compound 1 | 6 | NUBIAN | 3 | 8.0 |
| | | | | | | | BLACK | | |
| | | | | | | | TN-87 | | |
| Toner particle 3 | Binder resin 3 | 100 | Nipex35 | 10 | Ester compound 1 | 6 | NUBIAN | 3 | 7.7 |
| | | | | | | | BLACK | | |
| | | | | | | | TN-87 | | |
| Toner particle 4 | Binder resin 1 | 100 | Nipex35 | 10 | Ester compound 2 | 6 | NUBIAN | 3 | 7.6 |
| | | | | | | | BLACK | | |
| | | | | | | | TN-87 | | |
| Toner particle 5 | Binder resin 1 | 100 | Nipex35 | 10 | Ester compound 3 | 6 | NUBIAN | 3 | 7.6 |
| | | | | | | | BLACK | | |
| | | | | | | | TN-87 | | |
| Toner particle 6 | Binder resin 1 | 100 | Nipex35 | 10 | Ester compound 4 | 6 | NUBIAN | 3 | 7.8 |
| | | | | | | | BLACK | | |
| | | | | | | | TN-87 | | |
| Toner particle 7 | Binder resin 1 | 100 | Nipex35 | 10 | Ester compound 1 | 6 | — | — | 7.7 |
| Toner particle 8 | Binder resin 4 | 100 | Nipex35 | 10 | Ester compound 1 | 6 | NUBIAN | 3 | 7.8 |
| | | | | | | | BLACK | | |
| | | | | | | | TN-87 | | |
| Toner particle 9 | Binder resin 5 | 100 | Nipex35 | 10 | Ester compound 1 | 6 | NUBIAN | 3 | 7.8 |
| | | | | | | | BLACK | | |
| | | | | | | | TN-87 | | |
| Toner particle 10 | Binder resin 1 | 100 | Nipex35 | 10 | Ester compound 5 | 6 | NUBIAN | 3 | 7.7 |
| | | | | | | | BLACK | | |
| | | | | | | | TN-87 | | |
| Toner particle 11 | Binder resin 1 | 100 | Nipex35 | 10 | Ester compound 6 | 6 | NUBIAN | 3 | 7.6 |
| | | | | | | | BLACK | | |
| | | | | | | | TN-87 | | |

### Production Example of Silicone Resin Particles 1

### First Step

Into a reaction vessel equipped with a thermometer and a stirrer, 360 parts of water were added, and 15 parts of hydrochloric acid (5.0 mass %) were added to obtain a uniform solution. While this solution was stirred at 25° C., 136.0 parts of methyltrimethoxysilane were added, and the mixture was stirred for 5 hours. The mixture was then filtered to obtain a clear reaction solution containing a silanol compound or its partial condensate.

### Second Step

Into a reaction vessel equipped with a thermometer, a stirrer, and a dropping device, 440 parts of water were added, and 17 parts of 10.0 mass % ammonia water were added to prepare a uniform solution. While this solution was stirred at 35° C., 100 parts of the reaction solution obtained in the first step were added dropwise over 30 minutes, and the mixture was stirred for 6 hours to obtain a suspension. The resulting suspension was subjected to centrifugation to separate the fine particles, which were then collected and dried in a dryer at 200° C. for 24 hours.

### Third Step

After stirring and mixing 100 parts of the fine particles obtained in the second step, 3.75 parts of dimethyl silicone oil (KF-96-50cs, produced by Shin-Etsu Chemical Co., Ltd.), and 1,000 parts of ethanol, the solvent was removed using an evaporator, followed by drying to obtain silicone resin particles 1.

For the resulting silicone resin particles 1, the proportion of the T3 unit structure was determined by the above-described solid-state ²⁹Si NMR analysis. The proportion of the T3 unit structure was 0.5. In addition, silicone resin particles 1 were dispersed in toluene and allowed to stand for 24 hours, and then, the toluene-insoluble component was separated by centrifugation. The obtained insoluble component was dried at 120° C. for 2 hours, and the dry mass was measured. Based on the measured dry mass, the soluble component content of the silicone resin particles was calculated to be 0.5%. Furthermore, the weight-average molecular weight of the toluene-soluble component was determined by analyzing the component using the GPC measurement method described above. The weight-average molecular weight of the toluene-soluble component of silicone resin particles 1 was 5,000.

### Production Examples of Silicone Resin Particles 2 to 16

Silicone resin particles 2 to 16 were obtained in the same manner as in the Production Example of Silicone Resin Particles 1, except that the raw materials and process conditions were changed as presented in Tables 5-1 and 5-2. All silicone oils presented in Table 5-2 are products produced by Shin-Etsu Chemical Co., Ltd.

TABLE 5-1

| | First step | | | | | | Second step | | | | |
|---|---|---|---|---|---|---|---|---|---|---|---|
| | | Hydro- | | | | | First step | | | | |
| | | chloric | | | | | reaction | | Ammonia | Reaction | |
| | Water | acid | | | | | solution | Water | weter | start | Dropping |
| | [Mass | [Mass | Silane | Mass | Silane | Mass | [Mass | [Mass | [Mass | temperature | time |
| | parts] | parts] | compound 1 | parts | compound 2 | parts | parts] | parts] | parts] | [° C.] | [min] |
| Silicone resin | 360 | 10 | Methyltri- | 68 | Dimethyldi- | 68 | 100 | 440 | 11 | 35 | 30 |
| particles1 | | | methoxysilane | | methoxysilane | | | | | | |
| Silicone resin | 360 | 10 | Methyltri- | 68 | Dimethyldi- | 68 | 100 | 440 | 11 | 35 | 30 |
| particles2 | | | methoxysilane | | methoxysilane | | | | | | |
| Silicone resin | 360 | 10 | Methyltri- | 68 | Dimethyldi- | 68 | 100 | 440 | 11 | 35 | 30 |
| particles3 | | | methoxysilane | | methoxysilane | | | | | | |
| Silicone resin | 360 | 10 | Methyltri- | 68 | Dimethyldi- | 68 | 100 | 440 | 11 | 35 | 30 |
| particles4 | | | methoxysilane | | methoxysilane | | | | | | |
| Silicone resin | 360 | 10 | Methyltri- | 68 | Dimethyldi- | 68 | 100 | 440 | 11 | 35 | 30 |
| particles5 | | | methoxysilane | | methoxysilane | | | | | | |
| Silicone resin | 360 | 10 | Methyltri- | 68 | Dimethyldi- | 68 | 100 | 440 | 11 | 35 | 30 |
| particles6 | | | methoxysilane | | methoxysilane | | | | | | |
| Silicone resin | 360 | 10 | Methyltri- | 68 | Dimethyldi- | 68 | 100 | 440 | 11 | 35 | 30 |
| particles7 | | | methoxysilane | | methoxysilane | | | | | | |
| Silicone resin | 360 | 10 | Methyltri- | 68 | Dimethyldi- | 68 | 100 | 440 | 11 | 35 | 30 |
| particles8 | | | methoxysilane | | methoxysilane | | | | | | |
| Silicone resin | 360 | 10 | Methyltri- | 68 | Dimethyldi- | 68 | 100 | 440 | 11 | 35 | 30 |
| particles9 | | | methoxysilane | | methoxysilane | | | | | | |
| Silicone resin | 360 | 10 | Methyltri- | 54 | Dimethyldi- | 82 | 100 | 440 | 11 | 35 | 30 |
| particles10 | | | methoxysilane | | methoxysilane | | | | | | |
| Silicone resin | 360 | 10 | Methyltri- | 27 | Dimethyldi- | 109 | 100 | 440 | 11 | 35 | 30 |
| particles11 | | | methoxysilane | | methoxysilane | | | | | | |
| Silicone resin | 360 | 15 | Methyltri- | 136 | — | — | 100 | 440 | 17 | 35 | 30 |
| particles12 | | | methoxysilane | | | | | | | | |
| Silicone resin | 360 | 5 | Methyltri- | 68 | Dimethyldi- | 68 | 100 | 440 | 6 | 35 | 60 |
| particles13 | | | methoxysilane | | methoxysilane | | | | | | |
| Silicone resin | 360 | 5 | Methyltri- | 68 | Dimethyldi- | 68 | 100 | 440 | 6 | 35 | 50 |
| particles14 | | | methoxysilane | | methoxysilane | | | | | | |
| Silicone resin | 360 | 30 | Methyltri- | 68 | Dimethyldi- | 68 | 100 | 440 | 32 | 35 | 20 |
| particles15 | | | methoxysilane | | methoxysilane | | | | | | |
| Silicone resin | 360 | 30 | Methyltri- | 68 | Dimethyldi- | 68 | 100 | 440 | 32 | 35 | 15 |
| particles16 | | | methoxysilane | | methoxysilane | | | | | | |

TABLE 5-2

| | Third step | | | | | | |
|---|---|---|---|---|---|---|---|
| | Second | | | | | | |
| | step | | | | | | |
| | reaction | | | Number- | | Toluene- | Weight-average |
| | solution | | | average | Proportion | soluble | molecular weight |
| | [Mass | | Mass | particle size | of T3 unit | component | of toluene-soluble |
| | parts] | Silicone oil | parts | [nm] | structure | [mass %] | component |
| Silicone | 100 | KF-96-50 cs | 0.6 | 100 | 0.5 | 0.5 | 5000 |
| resin | | | | | | | |
| particles 1 | | | | | | | |
| Silicone | 100 | KF-96A-6 cs | 0.6 | 100 | 0.5 | 0.5 | 900 |
| resin | | | | | | | |
| particles 2 | | | | | | | |
| Silicone | 100 | KF-96-10 cs | 0.6 | 100 | 0.5 | 0.5 | 1000 |
| resin | | | | | | | |
| particles 3 | | | | | | | |
| Silicone | 100 | KF-96-200 cs | 0.6 | 100 | 0.5 | 0.5 | 10000 |
| resin | | | | | | | |
| particles 4 | | | | | | | |
| Silicone | 100 | KF-96-300 cs | 0.6 | 100 | 0.5 | 0.5 | 12000 |
| resin | | | | | | | |
| particles 5 | | | | | | | |
| Silicone | 100 | KF-96-50 cs | 0.2 | 100 | 0.5 | 0.1 | 5000 |
| resin | | | | | | | |
| particles 6 | | | | | | | |
| Silicone | 100 | KF-96-50 cs | 0.3 | 100 | 0.5 | 0.2 | 5000 |
| resin | | | | | | | |
| particles 7 | | | | | | | |
| Silicone | 100 | KF-96-50 cs | 5.2 | 100 | 0.5 | 5.0 | 5000 |
| resin | | | | | | | |
| particles 8 | | | | | | | |
| Silicone | 100 | KF-96-50 cs | 5.8 | 100 | 0.5 | 5.5 | 5000 |
| resin | | | | | | | |
| particles 9 | | | | | | | |
| Silicone | 100 | KF-96-50 cs | 0.6 | 100 | 0.4 | 0.5 | 5000 |
| resin | | | | | | | |
| particles 10 | | | | | | | |
| Silicone | 100 | KF-96-50 cs | 0.6 | 100 | 0.2 | 0.5 | 5000 |
| resin | | | | | | | |
| particles 11 | | | | | | | |
| Silicone | 100 | KF-96-50 cs | 0.6 | 100 | 1.0 | 0.5 | 5000 |
| resin | | | | | | | |
| particles 12 | | | | | | | |
| Silicone | 100 | KF-96-50 cs | 0.6 | 36 | 0.5 | 0.5 | 5000 |
| resin | | | | | | | |
| particles 13 | | | | | | | |
| Silicone | 100 | KF-96-50 cs | 0.6 | 45 | 0.5 | 0.5 | 5000 |
| resin | | | | | | | |
| particles 14 | | | | | | | |
| Silicone | 100 | KF-96-50 cs | 0.6 | 480 | 0.5 | 0.5 | 5000 |
| resin | | | | | | | |
| particles 15 | | | | | | | |
| Silicone | 100 | KF-96-50 cs | 0.6 | 500 | 0.5 | 0.5 | 5000 |
| resin | | | | | | | |
| particles 16 | | | | | | | |

### Production Example of Toner 1

Toner particle 1: 100 parts
Silicone resin particles 1: 0.5 part
Alumina particles (AA-04, manufactured by Sumitomo Chemical Co., Ltd.): 0.5 part

The raw materials presented above were added to an FM Mixer (Model FM10C, manufactured by Nippon Coke & Engineering Co., Ltd.) under conditions where the water temperature inside the jacket of the mixer was stable at 50° C.±1° C. Mixing was started at a peripheral speed of 38 m/s for the rotating blades, and the mixture was stirred for 7 minutes while the water temperature and flow rate in the jacket were controlled to maintain a stable temperature of 50° C.±1° C. inside the vessel. The resulting mixture was passed through a sieve having a mesh opening of 75 μm to yield Toner 1.

The binder resin component and the ester compound component of Toner 1 were separated using the above-described GPEC method. The resulting binder resin component was analyzed by ¹H NMR and reactive pyrolysis GC/MS, and it was confirmed that the binder resin contains an alkenylsuccinic unit having an alkenyl group with 18 carbon atoms. Also, the resulting ester compound was analyzed by reactive pyrolysis GC/MS, and it was confirmed that the ester compound contains a carboxylic unit having 18 carbon atoms.

The mass ratio between the silicone resin particles and the alumina particles was determined by analysis using the above-described X-ray fluorescence method. The obtained mass ratio of the silicone resin particles to the alumina particles was 50/50. Furthermore, the silicone resin particles and alumina particles were observed by SEM according to the above-described method to determine their number-average particle sizes. The number-average particle size of the silicone resin particles was 100 nm. The number-average particle size of the alumina particles was 500 nm.

### Preparation Examples of Toners 2 to 32

Toners 2 to 32 were obtained in the same manner as in the Production Example of Toner 1, except that the raw materials added were changed as presented in Table 6.

TABLE 6

| | | Mass | | Mass | | Mass |
|---|---|---|---|---|---|---|
| | Toner particle | parts | Silicone resin particles | parts | Alumina particles | parts |
| Toner 1 | Toner particle 1 | 100 | Silicone resin particles1 | 0.50 | AA-04 | 0.50 |
| Toner 2 | Toner particle 2 | 100 | Silicone resin particles1 | 0.50 | AA-04 | 0.50 |
| Toner 3 | Toner particle 3 | 100 | Silicone resin particles1 | 0.50 | AA-04 | 0.50 |
| Toner 4 | Toner particle 4 | 100 | Silicone resin particles1 | 0.50 | AA-04 | 0.50 |
| Toner 5 | Toner particle 5 | 100 | Silicone resin particles1 | 0.50 | AA-04 | 0.50 |
| Toner 6 | Toner particle 6 | 100 | Silicone resin particles1 | 0.50 | AA-04 | 0.50 |
| Toner 7 | Toner particle 1 | 100 | Silicone resin particles2 | 0.50 | AA-04 | 0.50 |
| Toner 8 | Toner particle 1 | 100 | Silicone resin particles3 | 0.50 | AA-04 | 0.50 |
| Toner 9 | Toner particle 1 | 100 | Silicone resin particles4 | 0.50 | AA-04 | 0.50 |
| Toner 10 | Toner particle 1 | 100 | Silicone resin particles5 | 0.50 | AA-04 | 0.50 |
| Toner 11 | Toner particle 1 | 100 | Silicone resin particles6 | 0.50 | AA-04 | 0.50 |
| Toner 12 | Toner particle 1 | 100 | Silicone resin particles7 | 0.50 | AA-04 | 0.50 |
| Toner 13 | Toner particle 1 | 100 | Silicone resin particles8 | 0.50 | AA-04 | 0.50 |
| Toner 14 | Toner particle 1 | 100 | Silicone resin particles9 | 0.50 | AA-04 | 0.50 |
| Toner 15 | Toner particle 1 | 100 | Silicone resin particles10 | 0.50 | AA-04 | 0.50 |
| Toner 16 | Toner particle 1 | 100 | Silicone resin particles11 | 0.50 | AA-04 | 0.50 |
| Toner 17 | Toner particle 1 | 100 | Silicone resin particles12 | 0.50 | AA-04 | 0.50 |
| Toner 18 | Toner particle 1 | 100 | Silicone resin particles13 | 0.50 | AA-07 | 0.50 |
| Toner 19 | Toner particle 1 | 100 | Silicone resin particles14 | 0.50 | AA-07 | 0.50 |
| Toner 20 | Toner particle 1 | 100 | Silicone resin particles15 | 0.50 | AA-04 | 0.50 |
| Toner 21 | Toner particle 1 | 100 | Silicone resin particles16 | 0.50 | AA-04 | 0.50 |
| Toner 22 | Toner particle 1 | 100 | Silicone resin particles1 | 0.30 | AA-04 | 0.70 |
| Toner 23 | Toner particle 1 | 100 | Silicone resin particles1 | 0.25 | AA-04 | 0.75 |
| Toner 24 | Toner particle 1 | 100 | Silicone resin particles1 | 0.70 | AA-04 | 0.30 |
| Toner 25 | Toner particle 1 | 100 | Silicone resin particles1 | 0.75 | AA-04 | 0.25 |
| Toner 26 | Toner particle 1 | 100 | Silicone resin particles1 | 0.50 | — | — |
| Toner 27 | Toner particle 1 | 100 | — | — | AA-04 | 0.50 |
| Toner 28 | Toner particle 7 | 100 | Silicone resin particles1 | 0.50 | AA-04 | 0.50 |
| Toner 29 | Toner particle 8 | 100 | Silicone resin particles1 | 0.50 | AA-04 | 0.50 |
| Toner 30 | Toner particle 9 | 100 | Silicone resin particles1 | 0.50 | AA-04 | 0.50 |
| Toner 31 | Toner particle 10 | 100 | Silicone resin particles1 | 0.50 | AA-04 | 0.50 |
| Toner 32 | Toner particle 11 | 100 | Silicone resin particles1 | 0.50 | AA-04 | 0.50 |

### Example 1

A laser printer (trade name: HP Color Laser Jet Enterprise M653dn, manufactured by HP Inc.; printing speed: 56 pages per minute (A4 size)) was prepared as an electrophotographic apparatus. A process cartridge dedicated to this electrophotographic apparatus was filled with Toner 1. The electrophotographic apparatus and the process cartridge were allowed to stand under low-temperature, low-humidity conditions (temperature: 15° C., relative humidity: 100%) for 24 hours or longer to acclimate sufficiently to the environment. Then, the process cartridge was mounted in the electrophotographic apparatus for the following evaluations. A4 color laser copy paper (manufactured by Canon Inc., 80 g/m²) was used as the test paper.

### Evaluation of Developing-Roller Filming

A durability test was conducted in which an image of the alphabet letter “E,” adjusted so that its coverage would be 1% of the area of an A4 sheet (hereinafter referred to as an “E-character image”), was repeatedly printed. In the durability test, two E-character images were printed, after which the rotation of the photosensitive drum was completely stopped for about 5 seconds, and then, image output was resumed. This intermittent image forming operation was repeated to output 50,000 electrophotographic images.

After outputting 50,000 sheets, a halftone image was printed, and the occurrence of vertical streaks arising from density unevenness due to developing-roller filming was evaluated according to the following criteria.

The evaluation results are presented in Table 7-1 to 7-3.
Rank A: No vertical streaks
Rank B: One vertical streak
Rank C: Two to four vertical streaks
Rank D: Five or more vertical streaks

### Evaluation of Fogging

A solid white image was printed on a test sheet whose reflection density had been measured in advance, using the process cartridge after the above-described evaluation of developing-roller filming, and the difference in reflection density before and after image output was taken as the fogging value. The fogging value obtained was evaluated according to the following criteria:
Rank A: less than 1%
Rank B: 1% to less than 2.5%
Rank C: 2.5% to less than 5%
Rank D: 5% to less than 10%

### Examples 2 to 26, Comparative Examples 1 to 6

Evaluations were conducted in the same manner as in Example 1 except that the toner filled in the process cartridge was changed to the combinations presented in Table 7-1 to 7-3. The evaluation results are presented in Table 7-1 to 7-3.

TABLE 7-1

| | | | | | nigrosine |
|---|---|---|---|---|---|
| | | | | | compound |
| | | Alkenylsuccinic acid | Ester compound | | Content |
| | | Alkenyl group carbon | | Carboxylic acid unit | [Mass |
| | | number | Alcohol unit | carbon number | parts] |
| Example 1 | Toner 1 | 18 | Dipentaerythritol | 18 | 3 |
| Example 2 | Toner 2 | 10 | Dipentaerythritol | 18 | 3 |
| Example 3 | Toner 3 | 22 | Dipentaerythritol | 18 | 3 |
| Example 4 | Toner 4 | 18 | Dipentaerythritol | 10 | 3 |
| Example 5 | Toner 5 | 18 | Dipentaerythritol | 22 | 3 |
| Example 6 | Toner 6 | 18 | Pentaerythritol | 18 | 3 |
| Example 7 | Toner 7 | 18 | Dipentaerythritol | 18 | 3 |
| Example 8 | Toner 8 | 18 | Dipentaerythritol | 18 | 3 |
| Example 9 | Toner 9 | 18 | Dipentaerythritol | 18 | 3 |
| Example 10 | Toner 10 | 18 | Dipentaerythritol | 18 | 3 |
| Example 11 | Toner 11 | 18 | Dipentaerythritol | 18 | 3 |
| Example 12 | Toner 12 | 18 | Dipentaerythritol | 18 | 3 |
| Example 13 | Toner 13 | 18 | Dipentaerythritol | 18 | 3 |
| Example 14 | Toner 14 | 18 | Dipentaerythritol | 18 | 3 |
| Example 15 | Toner 15 | 18 | Dipentaerythritol | 18 | 3 |
| Example 16 | Toner 16 | 18 | Dipentaerythritol | 18 | 3 |
| Example 17 | Toner 17 | 18 | Dipentaerythritol | 18 | 3 |
| Example 18 | Toner 18 | 18 | Dipentaerythritol | 18 | 3 |
| Example 19 | Toner 19 | 18 | Dipentaerythritol | 18 | 3 |
| Example 20 | Toner 20 | 18 | Dipentaerythritol | 18 | 3 |
| Example 21 | Toner 21 | 18 | Dipentaerythritol | 18 | 3 |
| Example 22 | Toner 22 | 18 | Dipentaerythritol | 18 | 3 |
| Example 23 | Toner 23 | 18 | Dipentaerythritol | 18 | 3 |
| Example 24 | Toner 24 | 18 | Dipentaerythritol | 18 | 3 |
| Example 25 | Toner 25 | 18 | Dipentaerythritol | 18 | 3 |
| Example 26 | Toner 26 | 18 | Dipentaerythritol | 18 | 3 |
| Comparative | Toner 27 | 18 | Dipentaerythritol | 18 | 3 |
| Example 1 | | | | | |
| Comparative | Toner 28 | 18 | Dipentaerythritol | 18 | — |
| Example 2 | | | | | |
| Comparative | Toner 29 | 9 | Dipentaerythritol | 18 | 3 |
| Example 3 | | | | | |
| Comparative | Toner 30 | 23 | Dipentaerythritol | 18 | 3 |
| Example 4 | | | | | |
| Comparative | Toner 31 | 18 | Dipentaerythritol | 9 | 3 |
| Example 5 | | | | | |
| Comparative | Toner 32 | 18 | Dipentaerythritol | 23 | 3 |
| Example 6 | | | | | |

TABLE 7-2

| | | Silicone resin particles | | | | |
|---|---|---|---|---|---|---|
| | | | | | Toluene- | Weight-average |
| | | Content | particle | Proportion | soluble | molecular weight of |
| | | [Mass | size | of T3 unit | Component | toluene-soluble |
| | | parts] | [nm] | structure | [mass %] | component |
| Example 1 | Toner 1 | 0.50 | 100 | 0.5 | 0.5 | 5000 |
| Example 2 | Toner 2 | 0.50 | 100 | 0.5 | 0.5 | 5000 |
| Example 3 | Toner 3 | 0.50 | 100 | 0.5 | 0.5 | 5000 |
| Example 4 | Toner 4 | 0.50 | 100 | 0.5 | 0.5 | 5000 |
| Example 5 | Toner 5 | 0.50 | 100 | 0.5 | 0.5 | 5000 |
| Example 6 | Toner 6 | 0.50 | 100 | 0.5 | 0.5 | 5000 |
| Example 7 | Toner 7 | 0.50 | 100 | 0.5 | 0.5 | 900 |
| Example 8 | Toner 8 | 0.50 | 100 | 0.5 | 0.5 | 1000 |
| Example 9 | Toner 9 | 0.50 | 100 | 0.5 | 0.5 | 10000 |
| Example 10 | Toner 10 | 0.50 | 100 | 0.5 | 0.5 | 12000 |
| Example 11 | Toner 11 | 0.50 | 100 | 0.5 | 0.1 | 5000 |
| Example 12 | Toner 12 | 0.50 | 100 | 0.5 | 0.2 | 5000 |
| Example 13 | Toner 13 | 0.50 | 100 | 0.5 | 5.0 | 5000 |
| Example 14 | Toner 14 | 0.50 | 100 | 0.5 | 5.5 | 5000 |
| Example 15 | Toner 15 | 0.50 | 100 | 0.4 | 0.5 | 5000 |
| Example 16 | Toner 16 | 0.50 | 100 | 0.2 | 0.5 | 5000 |
| Example 17 | Toner 17 | 0.50 | 100 | 1.0 | 0.5 | 5000 |
| Example 18 | Toner 18 | 0.50 | 36 | 0.5 | 0.5 | 5000 |
| Example 19 | Toner 19 | 0.50 | 45 | 0.5 | 0.5 | 5000 |
| Example 20 | Toner 20 | 0.50 | 480 | 0.5 | 0.5 | 5000 |
| Example 21 | Toner 21 | 0.50 | 500 | 0.5 | 0.5 | 5000 |
| Example 22 | Toner 22 | 0.30 | 100 | 0.5 | 0.5 | 5000 |
| Example 23 | Toner 23 | 0.25 | 100 | 0.5 | 0.5 | 5000 |
| Example 24 | Toner 24 | 0.70 | 100 | 0.5 | 0.5 | 5000 |
| Example 25 | Toner 25 | 0.75 | 100 | 0.5 | 0.5 | 5000 |
| Example 26 | Toner 26 | 0.50 | 100 | 0.5 | 0.5 | 5000 |
| Comparative | Toner 27 | — | — | — | — | — |
| Example 1 | | | | | | |
| Comparative | Toner 28 | 0.50 | 100 | 0.5 | 0.5 | 5000 |
| Example 2 | | | | | | |
| Comparative | Toner 29 | 0.50 | 100 | 0.5 | 0.5 | 5000 |
| Example 3 | | | | | | |
| Comparative | Toner 30 | 0.50 | 100 | 0.5 | 0.5 | 5000 |
| Example 4 | | | | | | |
| Comparative | Toner 31 | 0.50 | 100 | 0.5 | 0.5 | 5000 |
| Example 5 | | | | | | |
| Comparative | Toner 32 | 0.50 | 100 | 0.5 | 0.5 | 5000 |
| Example 6 | | | | | | |

TABLE 7-3

| | | | | | Particle size | | |
|---|---|---|---|---|---|---|---|
| | | | | Mass ratio | ratio of | | |
| | | | | of silicone | silicone | | |
| | | Alumina particles | | resin | resin | Evaluation result | |
| | | Content | particle | particles | particles to | Developing- | |
| | | [Mass | size | to alumina | alumina | Roller | |
| | | parts] | [nm] | particles | particles | Filming | Fogging |
| Example 1 | Toner 1 | 0.50 | 500 | 50/50 | 0.20 | A | A (0.5) |
| Example 2 | Toner 2 | 0.50 | 500 | 50/50 | 0.20 | C | A (0.6) |
| Example 3 | Toner 3 | 0.50 | 500 | 50/50 | 0.20 | C | A (0.8) |
| Example 4 | Toner 4 | 0.50 | 500 | 50/50 | 0.20 | C | A (0.7) |
| Example 5 | Toner 5 | 0.50 | 500 | 50/50 | 0.20 | C | A (0.7) |
| Example 6 | Toner 6 | 0.50 | 500 | 50/50 | 0.20 | A | A (0.6) |
| Example 7 | Toner 7 | 0.50 | 500 | 50/50 | 0.20 | B | A (0.8) |
| Example 8 | Toner 8 | 0.50 | 500 | 50/50 | 0.20 | A | A (0.6) |
| Example 9 | Toner 9 | 0.50 | 500 | 50/50 | 0.20 | A | A (0.6) |
| Example 10 | Toner 10 | 0.50 | 500 | 50/50 | 0.20 | B | A (0.7) |
| Example 11 | Toner 11 | 0.50 | 500 | 50/50 | 0.20 | B | A (0.6) |
| Example 12 | Toner 12 | 0.50 | 500 | 50/50 | 0.20 | A | A (0.7) |
| Example 13 | Toner 13 | 0.50 | 500 | 50/50 | 0.20 | A | A (0.7) |
| Example 14 | Toner 14 | 0.50 | 500 | 50/50 | 0.20 | B | A (0.6) |
| Example 15 | Toner 15 | 0.50 | 500 | 50/50 | 0.20 | B | B (1.9) |
| Example 16 | Toner 16 | 0.50 | 500 | 50/50 | 0.20 | B | C (2.5) |
| Example 17 | Toner 17 | 0.50 | 500 | 50/50 | 0.20 | A | A (0.7) |
| Example 18 | Toner 18 | 0.50 | 900 | 50/50 | 0.04 | B | B (1.8) |
| Example 19 | Toner 19 | 0.50 | 900 | 50/50 | 0.05 | A | B (1.9) |
| Example 20 | Toner 20 | 0.50 | 500 | 50/50 | 0.96 | A | B (1.1) |
| Example 21 | Toner 21 | 0.50 | 500 | 50/50 | 1.00 | B | B (1.1) |
| Example 22 | Toner 22 | 0.70 | 500 | 30/70 | 0.20 | A | C (2.7) |
| Example 23 | Toner 23 | 0.75 | 500 | 25/75 | 0.20 | B | C (3.1) |
| Example 24 | Toner 24 | 0.30 | 500 | 70/30 | 0.20 | A | B (1.6) |
| Example 25 | Toner 25 | 0.25 | 500 | 75/25 | 0.20 | B | B (1.9) |
| Example 26 | Toner 26 | — | — | 100/0 | — | C | B (2.4) |
| Comparative | Toner 27 | 0.50 | 500 | 0/100 | — | D | D (5.1) |
| Example 1 | | | | | | | |
| Comparative | Toner 28 | 0.50 | 500 | 50/50 | 0.20 | D | D (5.8) |
| Example 2 | | | | | | | |
| Comparative | Toner 29 | 0.50 | 500 | 50/50 | 0.20 | D | A (0.8) |
| Example 3 | | | | | | | |
| Comparative | Toner 30 | 0.50 | 500 | 50/50 | 0.20 | D | A (0.8) |
| Example 4 | | | | | | | |
| Comparative | Toner 31 | 0.50 | 500 | 50/50 | 0.20 | D | B (1.2) |
| Example 5 | | | | | | | |
| Comparative | Toner 32 | 0.50 | 500 | 50/50 | 0.20 | D | B (1.0) |
| Example 6 | | | | | | | |

Table 7-1 to 7-3 shows that the toners of Examples 1 to 26 can suppress the occurrence of developing-roller filming and fogging.

In contrast, Comparative Example 1, which contained no silicone resin particles, and Comparative Example 2, which contained no nigrosine compound, exhibited poor suppression of developing-roller filming and fogging. Also, Comparative Examples 3 and 4, in which the alkenyl group of the alkenylsuccinic acid had 9 or 23 carbon atoms, exhibited poor suppression of developing-roller filming. In addition, Comparative Examples 5 and 6, in which the carboxylic unit of the ester compound had 9 or 23 carbon atoms, also exhibited poor suppression of developing-roller filming.

Thus, the toner of the present disclosure can suppress the occurrence of fogging and developing-roller filming and is capable of forming high-quality images even in higher-speed and longer-life electrophotographic image forming apparatuses.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-006521, filed Jan. 17, 2025 and No. 2025-245145, filed Dec. 11, 2025, which are hereby incorporated by reference herein in their entirety.

What is claimed is:

1. A toner comprising:
a toner particle; and
an external additive, wherein
(1) the toner particle comprises a binder resin, a positive-charge control agent, and an ester compound,
the binder resin comprises a resin having a vinyl polymer segment and a polyester segment containing an alkenylsuccinic unit having an alkenyl group with 10 to 22 carbon atoms,
the positive-charge control agent is a nigrosine compound, and
the ester compound is an ester of pentaerythritol or dipentaerythritol and a saturated or unsaturated aliphatic monocarboxylic acid with 10 to 22 carbon atoms; and
(2) the external additive comprises silicone resin particles.

2. The toner according to claim 1, wherein the external additive further comprises alumina particles.

3. The toner according to claim 2, wherein the mass ratio of the silicone resin particles to the alumina particles is 30:70 to 70:30.

4. The toner according to claim 2, wherein the silicone resin particles and the alumina particles satisfy relationship (1):
$$0.05 \leq A / B < 1. \qquad ( 1 )$$
wherein A(nm) represents the number-average particle size of the silicone resin particles, and B(nm) represents the number average particle size of the alumina particles.

5. The toner according to claim 2, wherein the mass ratio of the amount of the silicone resin particles to the amount of the alumina particles in the toner is 30:70 to 70:30.

6. The toner according to claim 1, wherein the silicone resin particles have a T3 unit structure represented by formula (2): 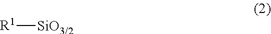
wherein in formula (2), R¹ represents an alkyl group with 1 to 6 carbon atoms.

7. The toner according to claim 5, wherein when the silicone resin particles are subjected to solid-state ²⁹Si NMR, the ratio of the peak area attributable to silicon in the T3 unit structure to the total peak area originating from all silicon atoms contained in the silicone resin particles is 0.50 to 1.00.

8. The toner according to claim 1, wherein the silicone resin particles contain a toluene-soluble component in an amount of 0.2% to 5.0% by mass.

9. The toner according to claim 8, wherein the toluene-soluble component has a polystyrene-equivalent weight average molecular weight, as determined by GPC, of 1,000 to 10,000.

10. A process cartridge capable of being removably mounted in an electrophotographic image forming apparatus, the process cartridge comprising:
a toner;
a developing roller that bears the toner; and
a toner regulating member that comes into contact with the developing roller to regulate the toner,
wherein
the toner comprises a toner particle and an external additive,
(1) the toner particle comprises a binder resin, a positive-charge control agent, and an ester compound,
the binder resin comprises a resin having a vinyl polymer segment and a polyester segment containing an alkenylsuccinic unit having an alkenyl group with 10 to 22 carbon atoms,
the positive-charge control agent is a nigrosine compound, and
the ester compound is an ester of pentaerythritol or dipentaerythritol and a saturated or unsaturated aliphatic monocarboxylic acid with 10 to 22 carbon atoms; and
(2) the external additive comprises silicone resin particles.

11. An electrophotographic image forming apparatus comprising:
a toner;
a photosensitive member on which an electrostatic latent image is formed;
a developing roller that bears the toner and develops the electrostatic latent image into a toner image; and
a toner regulating member that comes into contact with the developing roller to regulate the toner on the developing roller,
wherein
the toner comprises a toner particle and an external additive,
(1) the toner particle comprises a binder resin, a positive-charge control agent, and an ester compound,
the binder resin comprises a resin having a vinyl polymer segment and a polyester segment containing an alkenylsuccinic unit having an alkenyl group with 10 to 22 carbon atoms,
the positive-charge control agent is a nigrosine compound, and
the ester compound is an ester of pentaerythritol or dipentaerythritol and a saturated or unsaturated aliphatic monocarboxylic acid with 10 to 22 carbon atoms; and
(2) the external additive comprises silicone resin particles.
